(19) United States
(12) Patent Application Publication
(10) Pub. No.: US 2009/0262090 A1
(43) Pub. Date: Oct. 22, 2009

(54) INPUT DEVICE

(76) Inventor: Eui Jin OH, Daejeon (KR)

Correspondence Address: KNOBBE MARTENS OLSON & BEAR LLP, 2040 MAIN STREET, FOURTEENTH FLOOR, IRVINE, CA, 92614, US

(21) Appl. No.: 12/428,392

(22) Filed: Apr. 22, 2009

(30) Foreign Application Priority Data
Oct. 23, 2006 (KR) 10-2006-0102830
Feb. 15, 2007 (KR) 10-2007-0015832
Feb. 16, 2007 (KR) 10-2007-0016512
Apr. 24, 2007 (KR) 10-2007-0039789
Sep. 20, 2007 (KR) 10-2007-0095585

(51) Int. Cl. G06F 3/041

(52) U.S. Cl. 345/173

(57) ABSTRACT

An input device is disclosed. In one embodiment, the device includes i) a base comprising an input region, ii) at least one sensor provided at the input region and configured to sense a contact with the input region or a contact movement to the input region and iii) a controller configured to extract data corresponding to each input operation from a memory and receive the extracted data, according to the position of a contact point or the movement direction of the contact point sensed by the sensor relative to a reference position indicating section provided at the input region. According to one embodiment, the input device allows all desired characters, to be input, to be arranged in a minimum input region so as to be suitable for miniaturization, as well as allows each of the arranged characters to be inputted through only one-input operation so as to enable rapid and correct input of a character.

### RELATED APPLICATIONS

This application is a continuation application, and claims the benefit under 35 U.S.C. §§ 120 and 365 of PCT Application No. PCT/KR2007/005231, filed on Oct. 23, 2007, which is hereby incorporated by reference.

The PCT application also claimed priority to and the benefit of Korean Patent Applications Nos. 10-2006-0102830 filed on Oct. 23, 2006, 10-2007-0015832 filed on Feb. 15, 2007, 10-2007-0016512 filed on Feb. 16, 2007, 10-2007-0039789 filed on Apr. 24, 2007 and 10-2007-0095585 filed on Sep. 20, 2007, in the Korean Intellectual Property Office, all of which are incorporated herein by reference.

This application also relates to U.S. patent applications Nos. 12/358,148 and 12/358,161 both filed on Jan. 22, 2009 and 12/364,417 filed on Feb. 2, 2009, all of which are incorporated by reference.

### BACKGROUND OF THE INVENTION

1. Field of the Invention

The present invention relates to an input device, and more particularly, to such an input device which allows all the characters which it is desired to input to be arranged in a minimum input region so as to be suitable for miniaturization, as well as allows each of the arranged characters to be inputted through only one-input operation.

2. Description of the Related Technology

Along with the advancement of the software and semiconductor technology and the information process technology, information equipment is miniaturized gradually. Further, the number of characters inputted to such information equipment and its importance are increasing.

### SUMMARY OF CERTAIN INVENTIVE ASPECTS

One aspect of the present invention is an input device which allows all the characters which it is desired to input to be arranged in a minimum input region so as to be suitable for miniaturization, as well as allows each of the arranged characters to be inputted through only one-input operation so as to enable rapid and correct input of a character.

Another aspect of the present invention is an input device which minimizes both an erroneous input and movement of a user's finger based on directionality that anyone can know easily so as to enable rapid and correct input of a character.

Another object of the present invention is an input device which allows respective characters to be inputted in an identical position (one to-be-inputted object) according to an input operation so as to enable a large amount of data to be inputted in even a narrow area and can be applied to various information equipment to thereby accomplish lightness and miniaturization of the information equipment.

Another aspect of the present invention is an input device comprising: a base having an input region; one or more sensing sections provided at the input region for sensing a contact with the input region or a contact movement to the input region; and a control section for extracting data corresponding to each input operation from a memory and inputting the extracted data, according to the position of a contact point or the movement direction of the contact point sensed by the sensing section relative to a reference position indicating section provided at the input region.

The sensing section may allow the input region to be divided correspondingly to a plurality of direction indicating sections disposed at different circumferential positions spaced apart radially outwardly from the reference position indicating section, and the control section may extract and inputs data allocated to each direction indicating section corresponding to the sensing section that has sensed the contact.

The sensing section may be distributed on the entire area of the input region, the input region having a plurality of direction indicating sections disposed equidistantly at different circumferential positions spaced apart radially outwardly from the reference position indicating section.

The input operation may be performed in such a fashion that the contact point is moved radially outwardly from the reference position indicating section toward each of the direction indicating sections.

The input operation may be performed in such a fashion that the contact point is moved radially inwardly from each of the direction indicating sections toward the reference position indicating section.

The input operation may be performed in such a fashion that the contact point is moved from any one of the direction indicating sections to another direction indicating section while passing through the reference position indicating section.

The input operation may be performed in such a fashion that the contact point is moved from each of the direction indicating sections to the tangential direction of a circle having a predetermined radius from the center of the reference position indicating section.

The control section may input the data corresponding to each input operation by separating different signals depending on the movement direction of the contact point at the each direction indicating section.

The input operation may be performed in such a fashion that the contact point is moved in the circumferential direction around the reference position indicating section.

The control section extracts and inputs different characters depending on each direction indicating section which the input operation starts from and ends at, and the direction and the distance of the movement of the contact point for the input operation.

The input operation may be performed in such a fashion that the contact point is moved forward and rearward at respective direction indicating sections around the reference position indicating section.

The input operation may be performed in such a fashion that the contact point is moved leftward and rightward at respective direction indicating sections around the reference position indicating section.

The input operation may be performed in such a fashion that the contact point is moved forward and rearward, and leftward and rightward at respective direction indicating sections around the reference position indicating section.

The reference position indicating section comprises a reference input sensing section for sensing a contact therewith.

The respective input operations may be performed in a combination of more than two input operations so as to input a Korean character or an English character.

The respective input operations may be performed in an additional combination of more than one input operation so as to input a numeral, a symbol, a mode switch or a function.

The direction indicating sections are provided in any one of four to twelve directions.

In case where the input operation may be performed through the movement of the contact point, a multiple-stage input operation, i.e., a more than two-stage input operation is performed depending on a difference in the movement distance of the contact point.

The sensing section may comprise a depression sensing section at the bottom thereof for detecting the depression of each direction indicating section to thereby enable a multiple-stage input operation, i.e., a more than two-stage input operation depending on the strength of the depression.

The sensing section may comprise a touch pad provided at the input region.

The sensing section may comprise a touch screen.

The reference position indicating section or at least one of the direction indicating sections may comprise direction indicators for indicating the movement direction of the contact point for the input operation at the proximity thereof.

The direction indicators may display a character inputted by the input operation according to each direction indicator.

The direction indicators may vary in size and color depending on a character input mode in which a character is inputted.

The reference position indicating section may be provided so as to be movable in the input region.

A standby region may be positioned at one side of the input region comprises, and wherein when the contact point is moved to the standby region by a drag operation in a state where the reference position indicating section or any one of the direction indicators is touched, the direction indicator may be hidden into the touch screen and when the reference position indicating section is touched so as to return to the input region, the direction indicators may be re-displayed on the input region.

In this case, the reference position indicating section or the direction indicators may be provided so as to adjustable in transparency.

The reference position indicating section may be provided at least two in number so as to be arranged vertically at the edge of the input region and spaced apart from each other at a predetermined interval.

The reference position indicating section may be provided at least two in number so as to arranged horizontally at the left and right sides of the input region.

The reference position indicating section and the sensing section may be provided two in number, respectively, at the upper and lower positions or the left and right positions of the base adjacent to the touch screen.

The input device may further comprise a display section for displaying the character extracted by the control section thereon, the display section including a character display part for displaying characters, etc., assigned for the each input operation thereon.

The input device may further comprise a display section provided at the base for displaying the character extracted by the control section thereon, the display section including a character display part provided at one side thereof for displaying characters, etc., assigned for the each input operation thereon.

In case where the operation mode of the input device may be switched from a character input mode to a mouse input mode, the movement of a pointer is performed by the movement of the contact point and the left and right button functions of the mouse are performed by the touch of the mouse.

In case where the operation mode of the input device is switched from a character input mode to a joystick input mode, the movement of a game character may be performed by the movement of the contact point and various manipulation functions of the game character may be performed by the touch of the game character.

During the movement of the contact point, as the contact point goes far away from the reference position indicating section 30, the movement speed of the pointer or the game character may be gradually increased.

The reference position indicating section may be provided in two sets at the input region, such that the movement of the mouse pointer or the game character is performed by one of the two reference position indicating sections, and the functions of the left and right button of the mouse or various manipulation functions of the game character are performed by the other reference position indicating section.

The direction indicating sections may be provided eight in number so that the eight characters are inputted by touching them, and the contact point is moved radially inwardly from each of the eight direction indicating sections to the reference position indicating section and is moved radially outwardly from the reference position indicating section to each of the eight direction indicating sections so that a total of 24 characters can be inputted.

The direction indicating sections may be provided four in number so that the four characters are inputted by touching them, and the contact point is moved radially inwardly from each of the four direction indicating sections to the reference position indicating section and is moved radially outwardly from the reference position indicating section to each of the four direction indicating sections so that a total of 12 characters can be inputted, and where the reference position indicating section and the direction indicating sections are provided in pairs at the left and right sides of the input region so that a total of 24 characters can be inputted.

Another aspect of the present invention is an input device comprising: a touch sensing section in which an input region is provided; a reference position indicating section provided at the input region; four direction indicating sections disposed equidistantly at different circumferential positions spaced apart radially outwardly from the reference position indicating section; direction indicators provided at one side of the reference position indicating section and the each direction indicating section for indicating the movement direction of a contact point for the input operation performed at the reference position indicating section and the each direction indicating section; and a control section for extracting data corresponding to each input operation from a memory and inputting the extracted data, according to a contact with the each direction indicating section detected by the touch sensing section, the movement direction of the contact point passing through the reference position indicating section or the forward/rearward and leftward/rightward movement directions of the contact point at the each direction indicating section.

In this case, the touch sensing section may employ a touch screen.

The input device may further comprise four auxiliary direction indicating sections provided between the respective direction indicating sections.

Vowel characters may be inputted by the movement of the contact point passing through the reference position indicating section, consonant characters may be inputted by the forward/rearward and leftward/rightward movement directions of the contact point at the each direction indicating section, and various functional commands may be inputted by the contact with the each direction indicating section.

The reference position-indicating section, the direction indicating sections and the direction indicators may be provided two in number, respectively, at the left and right sides on the touch sensing section to thereby include two input sets.

The movement direction of the contact point passing through the reference position indicating section may be provided in the form of any one of four directions and eight directions.

Another aspect of the present invention is an input device comprising: a touch sensing section in which an input region is provided; a reference position indicating section provided at the input region; four direction indicating sections disposed equidistantly at different circumferential positions spaced apart radially outwardly from the reference position indicating section; direction indicators provided at one side of the reference position indicating section and the each direction indicating section for indicating the movement direction of a contact point for the input operation performed at the reference position indicating section and the each direction indicating section; a depression sensing section provided at the bottom thereof for detecting the depression of each direction indicating section; and a control section for extracting data corresponding to each input operation from a memory and inputting the extracted data, according to a contact with the each direction indicating section detected by the touch sensing section, the depression of the each direction indicating section detected by the depression sensing section, the movement direction of the contact point passing through the reference position indicating section and the forward/rearward and leftward/rightward movement directions of the contact point at the each direction indicating section.

In this case, the touch sensing section may employ a touch screen.

The consonant characters may be inputted by the forward/rearward and leftward/rightward movement directions of the contact point at the each direction indicating section, and vowel characters may be inputted by the contact with and depression of the each direction indicating section.

The input device may further comprise four auxiliary direction indicating sections provided between the respective direction indicating sections.

Vowel characters may be inputted by one of the contact with the each direction indicating section and the movement of the contact point passing through the reference position indicating section, and various functional commands may be inputted by the other.

The reference position indicating section, the direction indicating sections and the direction indicators may be provided two in number, respectively, at the left and right sides on the touch sensing section to thereby include two input sets.

Another aspect of the present invention is an input device comprising: a touch sensing section in which an input region is provided; a reference position indicating section provided two in number at the left and right sides at the input region; four direction indicating sections disposed equidistantly at different circumferential positions spaced apart radially outwardly from the reference position indicating section; direction indicators provided at one side of the reference position indicating section and the each direction indicating section for indicating the movement direction of a contact point for the input operation performed at the reference position indicating section and the each direction indicating section; and a control section for extracting data corresponding to each input operation from a memory and inputting the extracted data, according to a contact with the each direction indicating section detected by the touch sensing section, the movement direction of the contact point passing through the reference position indicating section and the movement directions of the contact point at the each direction indicating section.

In this case, the touch sensing section may employ a touch screen.

The movement directions of the contact point at the each direction indicating section may be set as any one of a forward/rearward direction and a leftward/rightward direction.

The movement directions of the contact point at the each direction indicating section may provided in at least one of an inward movement in which the contact point is moved inwardly from the each direction indicating section toward the reference position indicating section and an outward movement in which the contact point is moved outwardly from the each direction indicating section.

The direction indicating sections may further comprise four auxiliary direction indicating sections to thereby include a total of eight direction indicating sections, and the movement directions of the contact point at the each direction indicating section are provided in at least one of an inward movement in which the contact point is moved inwardly from the each direction indicating section toward the reference position indicating section and an outward movement in which the contact point is moved outwardly from the each direction indicating section.

The movement direction of the contact point passing through the reference position indicating section may be provided in the form of any one of four directions and eight directions.

The input device may further comprise four auxiliary direction indicating sections provided between the respective direction indicating sections.

Various functional commands may be inputted by the movement of the contact point passing through the reference position indicating section, and characters may be inputted by the contact with the each direction indicating section and the auxiliary direction indicating sections and the movement of the contact point at the each direction indicating section and the auxiliary direction indicating sections.

Vowel characters may be inputted by the contact with the each direction indicating section, and consonant characters may be inputted by the movement of the contact point at the each direction indicating section and the auxiliary direction indicating sections.

Another aspect of the present invention is an input device comprising: at least input sections having a plurality of input targets arranged circumferentially around a reference position; a sensing section for separately detecting a contact with each of the input targets and a contact movement at the each input target; and a control section for extracting data corresponding to each input target from a memory and inputting the extracted data, based on a detection result obtained by allowing the sensing section to detect a contact with the each input target, an outward contact movement in which the a contact point is moved outwardly from the reference position to the outside of the each input target, and an inward contact movement in which the contact point is moved inwardly from the reference position to the inside of the each input target.

In this case, the input section may have the shape of an annular ring formed integrally in its entirety.

Also, the input target for an inward contact movement-based input operation and an outward contact movement-based input operation among the input targets may include a direction indicator indicating a movement direction of the contact point for the input operation.

In addition, the input section may enable a circumferential contact movement-based input operation, and the control section determines the first input operation and the last input operation as a valid input operation when the contact point is moved along a circumferential path during the circumferential contact movement-based input operation and processes the input operation.

Furthermore, the control section performs the input operation after determining that a character corresponding to each input operation is inputted when at least two of a contact-based input operation, the inward contact movement-based input operation, the outward contact movement-based input operation and the circumferential contact movement-based input operation are detected as a one continuous input operation. Another aspect of the invention is an input device comprising: a base comprising an input region; at least one sensor provided at the input region and configured to sense a contact with the input region or a contact movement to the input region; and a controller configured to extract data corresponding to each input operation from a memory and receive the extracted data, according to the position of a contact point or the movement direction of the contact point sensed by the sensor relative to a reference position indicating section provided at the input region.

Still another aspect of the invention is an input device comprising: a base comprising an input region; means for sensing a contact with the input region or a contact movement to the input region, wherein the sensing means are provided at the input region; and means for extracting data corresponding to each input operation from a memory and receiving the extracted data, according to the position of a contact point or the movement direction of the contact point sensed by the sensing means relative to a reference position indicating section provided at the input region.

Furthermore, the input device enables to continuously perform various input operations such as a contact-based input, an inward contact movement-based input, an outward contact movement-based input and a circumferential contact movement-based input without releasing one press-contact to thereby allow for rapid input of a character. Moreover, a character arrangement according to each input is configured dividedly, and consonants and vowels of Hangeul are divided separately according to the character arrangement so that a one-input and several-phoneme input can be achieved through one successive input operation.

### BRIEF DESCRIPTION OF THE DRAWINGS

FIG. 1a is a perspective view showing an input device according to one embodiment of the present invention.

FIG. 1b is an enlarged view showing various modifications of a sensing section shown in FIG. 1a.

FIG. 2 is a front view showing an input device according to another embodiment of the present invention.

FIGS. 3a and 3b are schematic views showing various modifications of an input operation performed by an input device according to one embodiment of the present invention.

FIGS. 4a to 4f are enlarged views showing various modifications of a direction indicating section of an input device according to one embodiment of the present invention.

FIGS. 5a and 5b are schematic views showing various modifications of the arrangement of a reference position section and a direction indicating section of an input device according to one embodiment of the present invention.

FIGS. 6a to 6c are top plan views showing a state where an input device according to one embodiment of the present invention is provided in two sets.

FIGS. 7a and 7b are top plan views showing the state where a reference position section, a direction indicating section and a direction indicator of an input device according to one embodiment of the present invention are moved on a screen.

FIG. 8 is a state view showing an input device according to another embodiment of the present invention;

FIGS. 9a to 9e are state views showing various modifications of an input operation according to the embodiment shown in FIG. 8.

FIG. 10 is a state view showing modifications of an extension key according to the embodiment shown in FIG. 8.

FIG. 11 is a state view showing an input device according to another embodiment of the present invention.

FIG. 12 is a state view showing various modifications of an input operation according to the embodiment shown in FIG. 11.

FIG. 13 is a state view showing an input device according to another embodiment of the present invention.

FIG. 14 is a state view showing an input operation according to the embodiment shown in FIG. 13;

FIG. 15 is a state view showing an input device according to another embodiment of the present invention.

FIG. 16 is a state view showing various modifications of an input operation according to the embodiment shown in FIG. 15.

FIG. 17 is a state view showing an input device according to another embodiment of the present invention.

FIG. 18 is a state view showing an input operation according to the embodiment shown in FIG. 13.

FIG. 19 is a state view showing an input device according to another embodiment of the present invention.

FIG. 20 is a state view showing a modification of the embodiment shown in FIG. 19.

FIG. 21 is a state view showing another modification of the embodiment shown in FIG. 19.

FIG. 22 is a state view showing another modification of the embodiment shown in FIG. 19.

### DETAILED DESCRIPTION OF CERTAIN INVENTIVE EMBODIMENTS

Current information equipment causes a lot of problems when various characters and commands are inputted thereto. For example, an input device such as a keyboard used in personal computers (PCs) or notebook computers has a limitation in downsizing the input device. Thus, the input device has a difficulty in making the information equipment small-sized. Also, in case of a touch screen-type input device in employed in personal data assistances (PDAs) or a keypad-type input device employed in cellular phones, users suffer from an inconvenience that an input speed is low and a possibility of a mistaken input is high.

In order to more rapidly input characters, numerals, symbols or the like in information equipment such as the PCs, the notebook computers, the PDAs, the cellular phones, etc., a so-called one-operation and one phoneme (character)-input principle is desirable in which one phoneme (character) is inputted upon one-input operation. In case where the one-operation and one phoneme-input principle is performed on Hangeul or the Korean alphabet, buttons or input keys for inputting more than 24 characters need to be arranged on the information equipment. In case where the language of a character to be inputted is Japanese alphabet or another foreign language, a relatively increased number of buttons or input keys may be required for the input devices as compared to the case of Hangeul.

However, a typical input device used in various information equipment adopts an input scheme in which an associated character is assigned to each input key and the input key is tapped or depressed with a user's finger so as to input a character. Thus, it is difficult to arrange more than 24 input keys each having the size of a finger in a personal portable information terminal such as a cellular phone in which an arrangement area of input keys is small.

For this reason, it has been difficult to miniaturize a keyboard so far. In case of a cellular phone, since more than 24 Hangeul characters must be inputted using only 12 buttons, one button is inevitably overlappingly assigned with a plurality of characters. As a result, a repetitive input phenomenon frequently occurs in which a user depresses corresponding buttons twice or thrice in order to input one character (phoneme), which contributes to an increase of a character input time to thereby cause an inconvenience to the user.

Recently, the technology of small-sized terminals such cellular phones or PDAs follows a trend toward large-scale of the screen so as to efficiently provide more various information than TV, the Internet, etc., do. Accordingly, among products put on the market presently, some products employ a touch screen-type liquid crystal screen so that a user can input a character through the touch screen without eliminating a separate input space. In this case, the touch screen is advantageously maximized, but it is still difficult to arrange a sufficient number of keys for performing a character input and executing various functional commands on the touch screen. In other words, the entire screen cannot be assigned as an input keyboard. Also, in case where the size of a key is made small in order to arrange the sufficient number of keys on a partial region of the touch screen, small keys are densely arranged on the touch screen, thereby leading to erroneous typing during the input operation. Further, it is actually difficult to rapidly input a character as in a keyboard.

Furthermore, in case where a small number of keys are arranged on the touch-screen to magnify the size of keys, more than two keys generally need to be selected repetitively so as to input a desired character, making it impossible to rapidly input it.

In order to address and solve such problems, there has been proposed a character input method in which certain characters such as heaven(.), earth(—) and man( [symbol] ) meaning the three basic components of the universe are combined to input a desired character. However, this method still could not solve the repetitive input phenomenon. Further, in case of the English alphabet, an input method which is called ‘T9’ has been proposed. But such an input method encounters a problem in that the one-operation and one phoneme-input principle is not performed in which one phoneme (character) is inputted upon one-input operation.

Moreover, there has been proposed an input technique such as a keyboard which can be held by hand with it rolled up, a virtual laser keyboard in which when keys of the keyboard are projected onto the bottom and the projected keys are depressed using a finger above the bottom, the position of the used finger is sensed to achieve the input operation, or the like.

However, this kind of input device gives users an inconvenience of having to always carry around. Also, since such an input device has a problem in that since a character can be inputted only in a state where the input device is placed on the bottom, the input device is unsuitable for a personal portable information terminal which requires a character to be inputted with it held by hand during the traveling.

Reference will now be made in detail to embodiments of the present invention with reference to the attached drawings.

Referring to the drawings, an input device 1 comprises a base 10 having an input region 25; a plurality of sensing sections 20 provided at the input region 25 for sensing a contact with the input region or a contact movement to the input region; and a control section (not shown) for extracting data corresponding to each input operation from a memory (not shown) and inputting the extracted data according to the position of a contact point or the movement direction of the contact point sensed by the sensing section 20 relative to a reference position indicating portion 30 provided at one side of the input region 25.

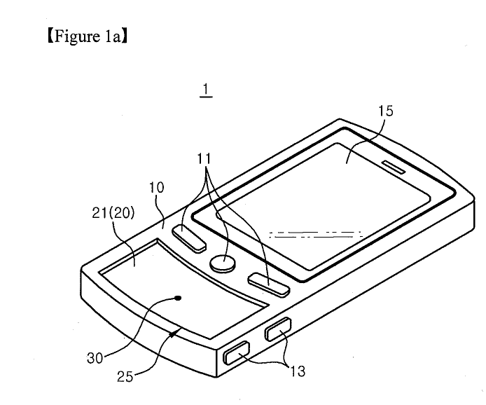

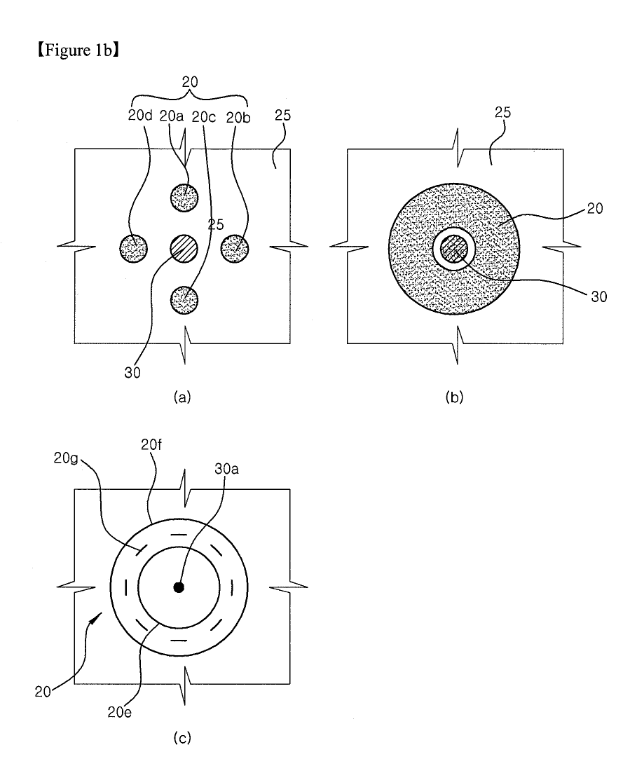

FIG. 1a is a perspective view showing an input device according to one embodiment of the present invention.

Referring to FIG. 1a, a sensing section 20 is disposed at the input region 25 provided at one side of the base 10 so as to sense a contact with the input region 25 or a contact movement to the input region.

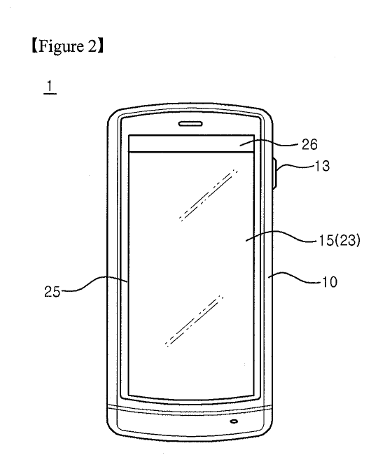

The sensing section 20 may be provided in various forms. For example, the sensing section 20 may be provided in the form of a touch pad 21 as shown in FIG. 1a, and may be provided with a contact (or touch) sensor, a pressure sensor, a depression-detecting sensor (switch), a resistive sensor or the like in plural numbers as shown in FIGS. 1b(a) to 1b(c). Alternatively, as shown in FIG. 2, the sensing section may be provided in the form of a touch screen 23 in which a display function is added to the touch pad 21.

Briefly, the sensing section 20 includes the touch pad 21 or the touch screen in which a display function is added to the touch pad 21, and a touch (contact) sensor which can sense a contact and a movement of a finger or an object.

Also, the sensing section 20 may be provided with one sensor, but may be formed in such a fashion as to be regularly arranged in plural numbers in a predetermined input space such as the touch pad 21 or the touch screen. In the meantime, in case where the sensing section 20 is provided in the form of the touch pad 21 or the touch screen 23, the input region is divided correspondingly to each direction indicating section 50 relative to the reference position indicating section, and the sensing section 20 may be formed in the divided input region 25.

Further, the sensing section 20 may be provided on the entire area of the input region 25 as shown in FIG. 1a, and may be provided in a certain area of a portion corresponding on each direction indicating section 50 which will be described later, as shown in FIG. 1b(a). In addition, the sensing section 20 may be provided on only a partial area of the input region 25 relative to the reference position indicating section 30 as shown in FIG. 1b(b), and may be provided on the input region 25 in the form of a line as shown in FIG. 1b(c).

Moreover, the reference position indicating section 30 may be further provided with a reference input sensing section (not shown) for sensing any contact with the reference position indicating section 30.

Meanwhile, the control section (not shown) is electrically connected to the sensing section 20 and serves to extract character data corresponding to each input operation from a memory (not shown) and input the extracted data, according to the position of a contact point or the movement direction of the contact point sensed by the sensing section 20 relative to the reference position indicating section 30 provided at one side of the input region.

### Embodiment 1

An input device according to a first embodiment of the present invention will be described hereinafter with reference to FIGS. 1a to 7b.

First, referring to FIGS. 1b(a) and 1b(b), a reference position indicating section 30 is provided at one side of an input region 25. The reference position indicating section 30 is a reference for a contact or a movement of a contact point sensed by a sensing section 20. Thus, the control section (not shown) determines the relative position of the contact point or the movement direction of based on the reference position indicating section 30.

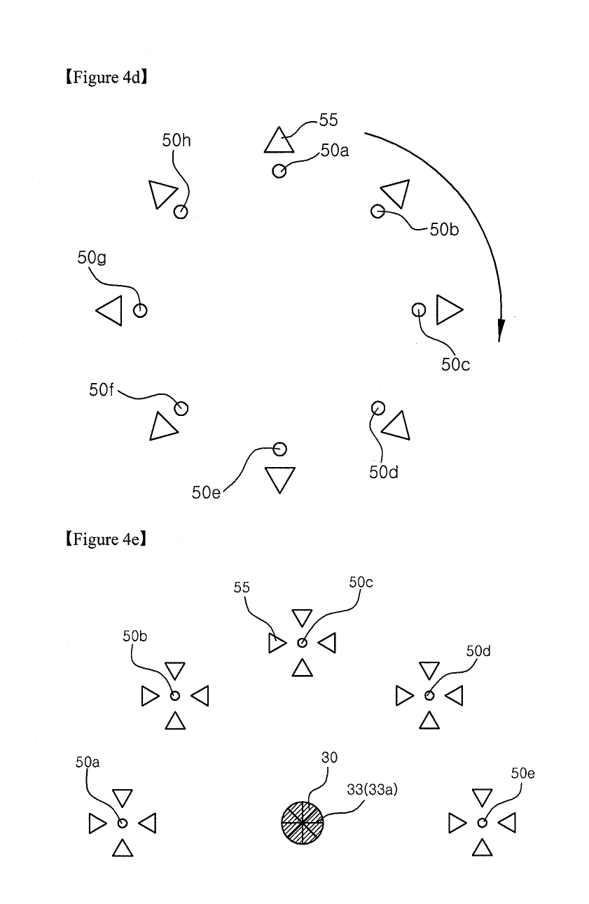

The reference position indicating section 30, as shown in FIGS. 1b(a) and 1b(b), may be fixedly provided on at one side of the input region 25. In case where the sensing section 20 is provided in the form of the touch pad 21 or the touch screen 23 as shown in FIGS. 1a and 2, the reference position indicating section 30 may be provided so as to be movable through a drag operation in the input region 25 as shown in FIGS. 7(a) and 7(b).

The latter case will be described hereinafter with reference to FIG. 2.

In case where the input device 1 is not in a character input mode, i.e., a standby mode, the reference position indicating section 30, the direction indicating section 50 or direction indicators 33 and 55 is positioned in a standby region 26 provided at one side of the touch screen 23. Then, if the operation mode is switched from the standby mode to the character input mode, a user can drag the reference position indicating section 30, the direction indicating section 50 or the direction indicators 33 and 55 positioned in a standby region 26 toward the input region 25 so as to perform a character input operation. In this case, the user can arbitrarily select the position of the reference position indicating section 30 for the purpose of inputting a character, thereby enhancing a convenience of the user.

Herein, the direction indicating section 50 and the direction indicator 55 can be configured such that they is not visible when positioned in the standby region 26, and appears on the input region 25 when moved to the input region 25. The reference position indicating section 30 can be also configured such that it disappears after the lapse of a predetermined time period from the time when it is positioned in the standby region 26, and then reappears when a user touches the standby region 26 or performs the movement operation for more than a predetermined time period after the touch of the standby region.

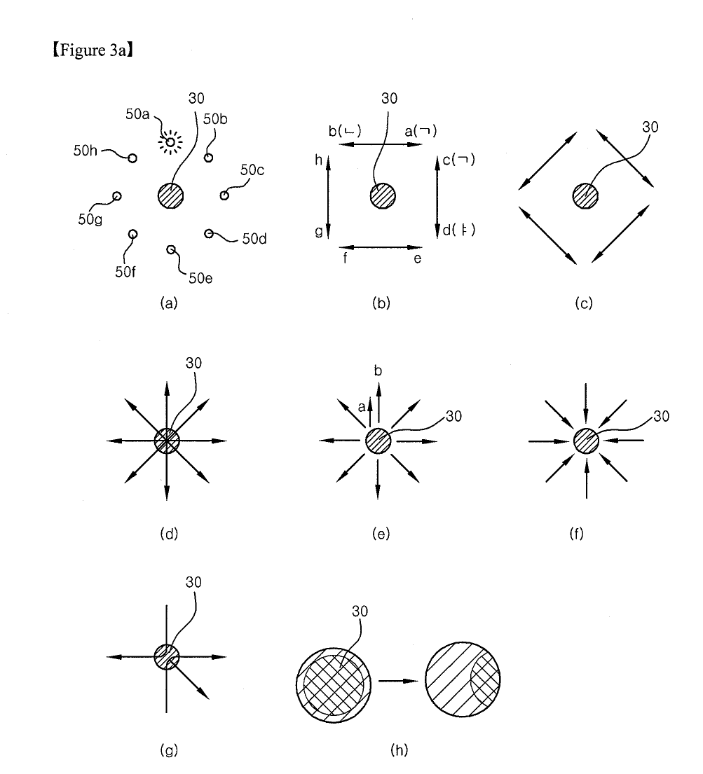

Referring to FIG. 3a(a), the direction indicating section 50 is disposed radially outwardly from the center of the reference position indicating section 30. Of course, in case where only four direction indicating sections 50 are provided, it is possible to dispose the four direction indicating sections 50 on the sensing sections 20a, 20b, 20c and 20d as shown in FIG. 1b(a).

In one embodiment, the direction indicating sections 50 are disposed at different circumferential positions spaced apart from radially outwardly from the reference position indicating section 30 in such a fashion as to be spaced apart from one another at regular intervals and at equal angles. Also, the direction indicating sections 50 may be provided in various numbers. For example, the four direction indicating sections 50 may be provided to correspond to the sensing sections 20a, 20b, 20c and 20d as shown in FIG. 1b(a), and eight direction indicating sections 50 may be provided as shown in FIG. 3a(a). Of course, it is possible to dispose 12 direction indicating sections 50.

Each direction indicating section 50 is assigned with a predetermined character so that when any contact with each direction indicating section 50 is sensed, the control section extracts an associated character assigned to each direction indicating section 50 from a memory and inputs the extracted character.

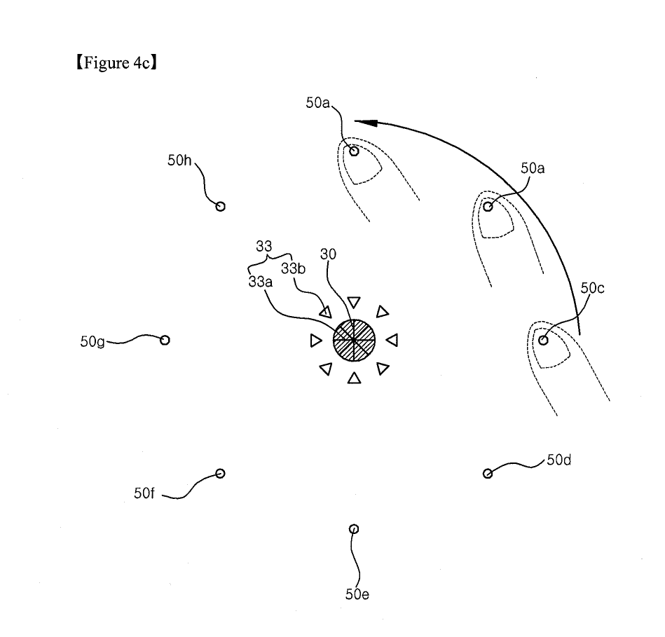

Here, as shown in FIG. 1a, a display section 15 can be provided at the other side of the base 10 so as to display a character extracted by the control section thereon. In this case, the display section 15 may be further provided with a character display part 56 (see FIGS. 6a and 6b) for displaying a character or the like assigned for each input operation based on the reference position indicating section 30.

The character display part 56 displays a character assigned for each input operation based on the reference position indicating section 30 so that a user can perform a character input operation while viewing the character display part 56. Of course, this character display part 56 may be configured such that it is made visible or is hidden by a user's manipulation.

Now, the basic input operation of the input device as constructed above according to this embodiment will be described hereinafter in detail with reference to FIGS. 3a and 3b.

The term ‘character’ as used herein, refers to consonants or vowels used to represent languages of each country such as Korean alphabet (Hangeul), English alphabet, Japanese alphabet, etc., and is defined as a narrow meaning excluding numerals, symbols or the like.

Referring to FIG. 3a, eight direction indicating sections 50a to 50h are disposed equidistantly at different circumferential positions spaced apart radially outwardly from the reference position indicating section 30. A character is assigned to each direction indicating section 50, so that when any contact with a corresponding direction indicating section 50a is sensed, the control section extracts a character code assigned to the sensed corresponding direction indicating section 50a from the memory and inputs the extracted character code.

In the meantime, the sensing section 20 may be further provided with a depression-sensing section (not shown) for sensing the depression of each direction indicating section 50 at a lower portion thereof. In this case, a two-stage input operation can be performed through the touching or depression of each direction indicating section 50. Alternatively, the depression-sensing section may be also provided in the form of a pressure sensor so as to enable a more than two-stage input operation according to the strength of depression of each direction indicating section 50 through only depression.

FIG. 3a(b) shows examples of various character inputs according to the movement direction of a contact point at the outside of the reference position indicating section 30.

For example, when the contact point is moved from the left to the right at a position above the reference position indicating section 30 (see ‘a’ of FIG. 3a(b)), a Hangeul consonant [symbol] is inputted, and when the contact point is moved from the right to the left at the position above the reference position indicating section 30 (see ‘b’ of FIG. 3a(b)), a Hangeul consonant [symbol] is inputted. Also, when the contact point is moved from the bottom to the top at the right side of the reference position indicating section 30 (see ‘c’ of FIG. 3b(b)), a Hangeul vowel [symbol] is inputted, and when the contact point is moved from the top to the bottom at the right side of the reference position indicating section 30 (see ‘d’ of FIG. 3b(b)), a Hangeul vowel [symbol] is inputted.

That is, the control section determines the movement direction of the contact point based on the coordinates of the initial and the last positions of the contact point by using the reference position indicating section 30 as an origin of coordinates when the movement of the contact point is sensed by the sensing section 20 to thereby extract a character code corresponding to each input operation by distinguishing the respective input operations from one another.

Similarly, FIG. 3a(c) shows a state where the contact point is moved at an oblique angle (for example, at an angle of 45 degrees) relative to the reference position indicating section 30. FIG. 3a(d) shows a state where the contact point is moved while passing w through the reference position indicating section 30. FIG. 3a(e) shows a state where the contact point is moved radially outwardly from the reference position indicating section 30 toward each of the direction indicating sections. FIG. 3a(f) shows a state where the contact point is moved radially inwardly from each of the direction indicating sections toward the reference position indicating section 30.

In the meantime, FIG. 3a(g) shows a state where the contact point passes through the reference position indicating section 30 at a given angle. That is, the contact point may be moved from a direction indicating section 50 positioned in the direction of the hour hand when the clock shows six o'clock to a direction indicating section 50 positioned in the direction of the hour hand when the clock shows three o'clock or four thirty via the reference position indicating section 30. Also, different characters an be inputted depending on the position from which the contact point starts and the position of a direction indicating section 50 which the contact point reaches via the reference position indicating section 30.

Further, FIG. 3a(h) shows a tilt input. The tilt input refers to an input method in which in a state where a user touches the reference position indicating section 30, when the user shifts a touch position from the reference position indicating section 30 to any one of the direction indicating sections 50 to thereby cause a variation in the initial touch area, a character is inputted which corresponds to the direction indicating section 50 being touched in the direction where a variation occurs in the touch area.

That is, when a character assigned to the direction indicating section 50c shown in FIG. 3a(a) is [symbol] and it is desired to input the character [symbol] a user first touches the reference position indicating section 30, and then shifts the contact point from the reference position indicating section 30 to the direction indicating section 50c while maintaining the contact, i.e., the state of being touched to thereby cause a variation in the touch area. In other words, the user can tilt his or her finger toward the direction indicating section 50c assigned with the Hangeul vowel [symbol] in a state where the user touches the reference position indicating section 30 with his or her finger.

As a result, a touch portion is formed at one side of the reference position indicating section 30 so as to have an area smaller than the area of the portion (indicated in the form of [symbol] in FIG. 3a(h)) which the user first touches the reference position indicating section 30. In this case, the touch portion having a smaller area indicates the direction of the hour hand when the clock shows three o'clock and a character [symbol] is assigned to the direction indicating section 50c positioned in the direction of the hour hand when the clock shows three o'clock, so that the Hangeul vowel [symbol] can inputted through the tilt input operation as shown in FIG. 3a(h).

In the meantime, when the tilt input operation as shown in FIG. 3a(h) is performed, the strength of the touch force applied to the sensing section may be changed to perform a multi-stage input operation.

Next, referring to FIG. 3b, FIG. 3b(a) shows a state where the contact point is moved forward and rearward at respective direction indicating sections 50 disposed at positions spaced apart radially outwardly from the reference position indicating section 30. FIG. 3b(b) shows a state where the contact point is moved leftward and rightward at respective direction indicating sections 50 disposed at different circumferential positions spaced apart radially outwardly from the reference position indicating section 30. FIG. 3b(c) shows a state where the contact point is moved forward and rearward, and leftward and rightward at respective direction indicating sections 50 disposed at different circumferential positions spaced apart radially outwardly from the reference position indicating section 30. FIGS. 3b(d) and 3b(e) show states where the contact point is moved in the circumferential direction around the reference position indicating section 30.

In brief, the input device 1 according to one embodiment of the present invention separately performs respective input operations such as an input based on the position of the contact point as shown in FIG. 3a(a) and an input based on the movement of the contact point as shown in FIG. 3a(b) to thereby input characters assigned to the respective input operations.

In this case, the respective input operations shown in FIGS. 3a and 3b may be applied separately or in a combination of more than two inputs.

First, the case where the above-mentioned respective input operations are applied separately will be described hereinafter.

In FIG. 3a(a), a total of eight characters can be inputted through the contact with eight direction indicating sections 50, a total of eight characters can also be inputted through the contact can be inputted through the movement of the contact point in FIG. 3a(b), and a total F of 16 characters can be inputted in such a fashion that four characters are inputted every oblique direction in FIG. 3a(b).

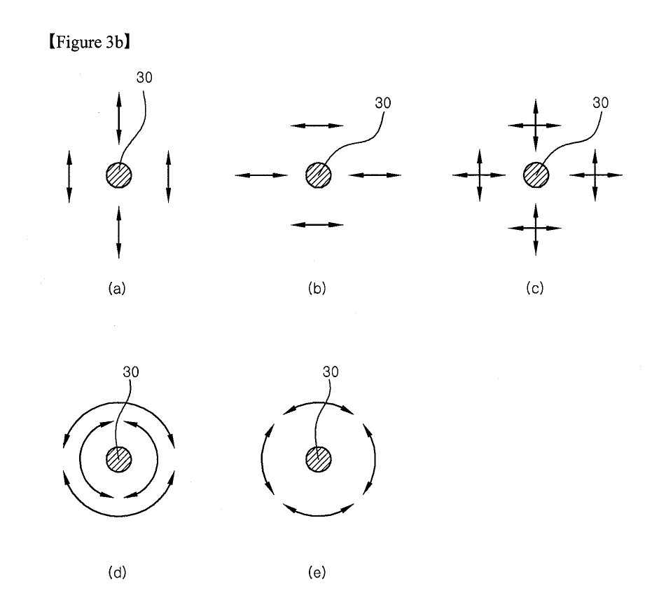

The concrete operation examples of the input device based on such various input operations will be described hereinafter with reference to FIGS. 4a to 4f.

In FIGS. 4a and 4b, there are shown four direction indicating sections 50a, 50b, 50c and 50d arranged around the reference position indicating section 30. But the input device may be configured such that eight direction indicating sections 50a to 50h as shown in FIG. 3a(a) or 12 direction indicating sections are arranged around the reference position indicating section 30, or five direction indicating sections 50a to 50e are radially arranged in a partial circumferential area around the reference position indicating sections 30 as shown in FIG. 4a(e).

Each of the direction indicating sections 50 may be provided with direction indicators 55 for indicating the movement direction of the contact point at the proximity of each direction indicating section 50. Also, a character to be inputted according to each input operation can be displayed on each direction indicator 55 or each direction indicating section 50 as shown in FIG. 4(f).

The case where more than two basic input operations are combined will be described hereinafter with reference to FIG. 4a.

FIG. 4a shows a combination of the input operations shown in FIG. 3a(a) and FIG. 3b(c).

That is, four direction indicating sections 50a, 50b, 50c and 50d are arranged around the reference position indicating section 30 so that four characters can be inputted through the contact with each direction indicating section 50 and 16 characters can be inputted through the movement of the contact point at each direction indicating section 50. As a result, a total of 20 characters can be inputted.

In this case, the number of the direction indicating sections 50 can be modified freely. Thus, if eight direction indicating section 50 are provided and the input of the character is possible through the four movements of the contact point at each direction indicating section 50 as shown in FIG. 3a(a), a total of 40 characters can be inputted.

Thus, in case of the Hangeul, all the 24 Korean characters can be sufficiently assigned to the direction indicating sections and the direction indicators, and in case of the English alphabet, all the 26 English characters can sufficiently be assigned to the direction indicating sections and the direction indicators. Spare characters or command keys such as cancel, enter, numeral, symbol and the like can be assigned to the direction indicating sections and the direction indicators with respect to the remaining input operations.

Also, in case where more than three basic input operations are combined, Korean characters, English characters, numerals, symbols as well as functions such as cancel, enter and the like can be assigned to the direction indicating sections and the direction indicators, so that a desired character can be inputted immediately even without any switch of an input mode.

Therefore, the input device 1 allows all the characters which it is desired to input to be arranged in a minimum input region on which the reference position indicating section 30 is disposed so as to be suitable for miniaturization, as well as allows each of the arranged characters to be inputted through only one-input operation so as to enable rapid and correct input of a character.

In addition, the input device may be configured such that in case of the input operation based on the movement of the contact point, respective input operations may be performed in a multi-stage input scheme depending on a difference in the movement distance of the contact point.

For example, in case of the input operation in which the contact point is moved form the reference position indicating section 30 to a direction indicating section 50 positioned in the direction of the hour hand when the clock shows 12 o'clock as shown in FIG. 3a(e), if the movement distance ‘a’ of the contact point is relatively short, the input operation is performed in a one-stage input scheme, and the movement distance ‘b’ of the contact point is relatively long, the input operation is performed in a two-stage input scheme, so that a total of 16 characters can be inputted through only the basic input operation of FIG. 3a(e).

In case where the input operation is performed through the movement of the contact point, a multiple-stage input operation, i.e., a more than two-stage input operation is performed depending on a difference in the movement distance of the contact point.

Alternatively, the sensing section 20 is further provided with a depression sensing section (not shown) at the bottom thereof for detecting the depression of each direction indicating section 50, so that the sensing section 20 detects any touch thereof by a user finger and the depression sensing section detects any depression of the sensing section to thereby enable the multiple-stage input operation, i.e., more than two-stage input operation. In addition, the depression sensing section may be provided in the form of a pressure sensor, etc., to thereby enable the multiple-stage input operation depending on the strength of the depression through only the depression.

In the meantime, the input device 1 may be configured such that a character can be inputted through the reference position indicating section 30 besides the respective basic input operations as described above.

For example, the input operation can be achieved through a contact with the reference position indicating section 30 or the movement of the contact point passing through the reference position indicating section 30 as shown FIG. 4a. That is, in FIG. 4a, eight characters can be inputted through only the reference position indicating section 30. In this case, the reference position indicating section 30 is further provided with direction indicators 33 for indicating the movement direction of the contact point for the input operations performed at the reference position indicating section 30.

The direction indicators 33; may be provided on the reference position indicating section 30 in the shape of lines or arrows divided depending on the movement direction of the contact point, and may be provided circumferentially around the reference position indicating section 30 in a triangular shape corresponding to each movement direction of the contract point as shown in FIG. 4b. In this case, a direction indicator formed in the shape of the direction dividing lines or arrows is denoted by reference numeral ‘33a’, and a direction indicator formed in the shape of the triangle is denoted by reference numeral ‘33b’.

As described above, the respective input operations, the multiple-stage configuration of the respective input operations and the character input operations through the reference position indicating section 30 can be applied separately or in a combination thereof to thereby enable all the characters which it is desired to input to be displayed.

In the meantime, in case where the respective basic input operations shown in FIGS. 3a and 3b and the input operation through the reference position indicating section 30 are combined, characters can be variously assigned for the respective input operations depending on the kind thereof.

For example, vowel characters such as Korean vowels, English vowels, etc., can be assigned for the respective input operations through the reference position indicating section 30, and consonant characters such as Korean consonants, English consonants, etc., can be assigned for the respective input operations performed at positions spaced apart outwardly from the reference position indicating section 30.

Also, the reference position indicating section 30 may be assigned with numerals, symbols or various functions such as cancel, enter and the like besides characters.

Further, vowel characters may be assigned for the input operation through a contact with each direction indicating section 50, consonant characters may be assigned for the input operation through the movement of the contact point, and numerals, symbols or various functions may be assigned for the input operation through the reference position indicating section 30.

In the meantime, as shown in FIG. 4b, auxiliary direction indicating sections 51a, 51b, 51c and 51d may further be provided between the respective direction indicating sections 50 which do not allow the input operation through the movement of the contact point to be performed. The auxiliary direction indicating sections 51a, 51b, 51c and 51d are configured such that they senses only any contact so as to allow characters assigned thereto to be inputted.

Further, the input device 1 may further include direction indicators 55 and 33 for indicating the movement direction of the contact point for the respective input operations and displaying characters to be inputted through the respective input operations.

For example, as shown in FIGS. 4a and 4b, the direction indicators 55 and 33b may be provided circumferentially around the each direction indicating section 50 and the reference position indicating section 30 in the triangular shape corresponding to each input operation.

Of course, the direction indicators 55 and 33, as shown in FIG. 4f, can be modified freely in shape and arrangement.

Meanwhile, as shown in FIG. 4f, each of the direction indicators 55 and 33b can display characters assigned for the respective input operations.

In this case, the characters displayed on the respective direction indicators 55 and 33b may be set to be modified depending on an input mode. For example, in case of a Korean character input mode, only Korean consonants and vowels are displayed on the respective direction indicators 55 and 33b. In case of an English character input mode, only English consonants and vowels are displayed on the respective direction indicators 55 and 33b. In addition, the direction indicators 55 and 33b can be hidden by a user's skillful manipulation.

In the meantime, a character display section 56 may be provided at one side of display section 15 or the touch screen 23 so as to allow each input operation and the characters assigned for the input operation to be displayed thereon in place of the direction indicators 55 and 33b provided circumferentially around the direction indicating sections 50 and the reference position indicating section 30. In this case, it is, of course, possible to modify the kind of characters to be displayed on the character display section 56 depending on an input mode.

Next, FIG. 4c shows an input operation based on a circumferential movement of the contact point. The input operation of FIG. 4c is performed in such a fashion that the contact point is moved in the circumferential direction around the reference position indicating section as shown in FIG. 3b(d) and 3b(e). Here, the circumferential contact movement-based input operation refers to an input scheme in which when a user touches a direction indicating section 50 with his/her finger and then circumferentially moves the contact point in a clockwise or counter-clockwise direction around the reference position indicating section 30, a character is inputted which is assigned to a direction indicating section 50 at a point where the circumferential contact movement-based input operation is finished.

Also, as shown in FIG. 4d, when the touch-based input operation and the circumferential contact movement-based input operation are performed, different types of characters can be inputted. For example, as shown in FIG. 4d, it is assumed that a first character is assigned to the direction indicating sections 50a to 50h and a second character is assigned to the direction indicator 55. In this case, when a touch-based input operation is performed, the first character assigned to the direction indicating sections 50a to 50h is inputted, and when an outward contact movement-based input operation is performed, the second character assigned to the direction indicator 55 is inputted.

At this time, it is assumed that after a character has been first inputted at a predetermined position and then a character has been finally inputted by performing the circumferential contact movement-based input operation, the character input operation is completed. In this case, if the first input operation is the touch-based input operation, the first character is inputted, and the first character is also inputted upon the final input operation. That is, two first characters are continuously inputted through the circumferential contact movement-based input operation.

Also, if the first input operation is the outward contact movement-based input operation, the second character is inputted, and the second character is also inputted upon the final input operation. That is, two first characters are continuously inputted through the circumferential contact movement-based input operation.

In this case, a character according to the first input is inputted upon the final input operation irrespective of whether the character input operation is completed through the touch-based input operation or the outward contact movement-based input operation.

Furthermore, the direction indicating section 50 and direction indicator 55 may be configured so as to be arranged in only a partial circumferential area spaced apart radially outwardly from the reference position indicating sections 30 as shown in FIG. 4e. That is, the direction indicating section 50 and direction indicator 55 can be, of course, disposed in a semicircular shape as well as in various shapes around the reference position indicating sections 30.

In the meantime, in providing two sets of input devices, the movement direction of the contact point at each direction indicating section 50 may be set such that a character is inputted only in the forward and rearward directions, the leftward and rightward directions, or the inward and outward directions.

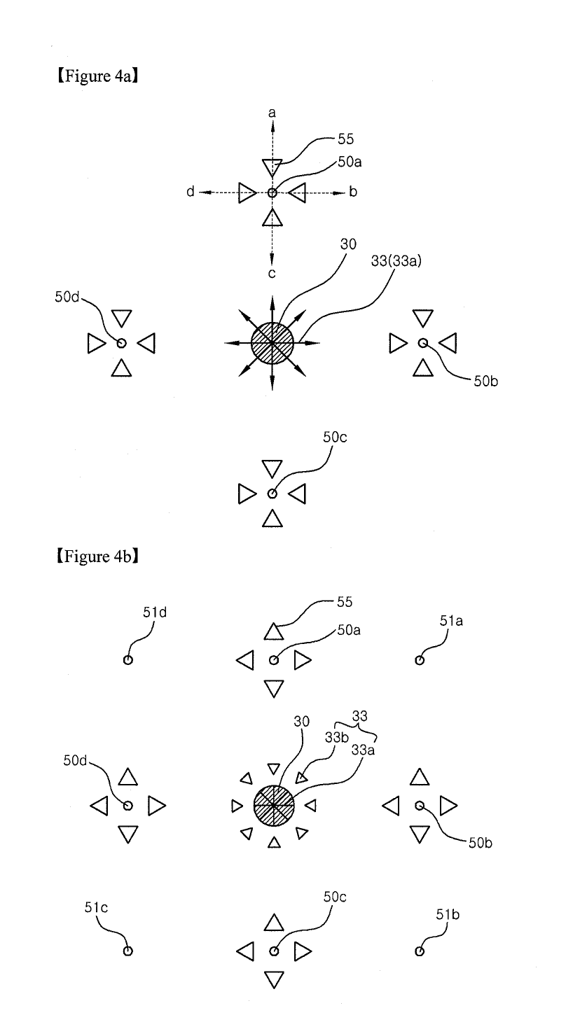

For example, as shown in FIGS. 5a and 5b, a reference position indicating section 30 is disposed at the right and left sides of the touch screen 23, respectively, and eight direction indicating sections 50a to 50h are disposed equidistantly at different circumferential positions spaced apart radially outwardly from the reference position indicating section 30. Each direction indicating section 50 may be configured to have only direction indicators 55 which indicate an outward contact movement (see FIG. 5a) or an inward contact movement (see FIG. 5b) of the contact point relative to the reference position indicating section 30.

The combination of the input operations included in each input device set can be, of course, modified depending on the kind of the input mode.

For example, a combination of the input operations shown in FIGS. 3a(a) and 3a(b) is used in a Korean character input mode, and a combination of the input operations shown in FIGS. 3a(a) and 3a(b) is used in an English character input mode.

In the meantime, as shown in FIG. 6a, a mode display section 57 can be provided at an upper left side of the display section 15 and the touch screen 23 so as to display a current character input mode.

Also, the input device 1 may include two reference position indicating sections 30 so as to have two sets of input devices. In this case, the two input device sets may be provided on the base 10, the touch pad 21 or the touch screen 23 as shown in FIGS. 6a to 6c.

In addition, the input device set may be arranged in a vertical direction as shown in FIG. 6a, and may be arranged in a horizontal direction as shown in FIG. 6b.

Further, the reference position indicating section 30, the direction indicating section 50 and the direction indicator 55 are provided in two sets, respectively, on the touch screen 23 as shown in FIG. 6c. In this case, various to-be-inputted objects such as Hangeul, foreign languages including English, Japanese, etc., special characters, symbols and the like can be displayed on the direction indicating section 50 and the direction indicator 55 provided in two sets in correspondence to the reference position indicating section 30.

In this manner, in case where two sets of input devices, are included, the respective two input device sets may be configured to perform the identical input operation, and may be configured to perform different input operations. That is, one of the two sets of input devices may be configured to use a combination of the input operations shown in FIG. 3a(a) and FIG. 3a(c), and the other of the two sets of input devices may be configured to use only the input operation shown in FIG. 3b(d).

The input device set shown in FIGS. 4a and 4b may be arranged at the right and left sides of the touch screen 23. In this case, vowel characters are inputted through the movement of the contact point passing through the reference position indicating section 30 and consonant characters are inputted through the forward/rearward and leftward/rightward movement of the contact point at each direction indicating section 50. Various functional commands such as enter, space, cancel, etc., are can be inputted through the contact of the contact point with each direction indicating section 50. In this case, the shape and arrangement of the input device set is not limited to the shape and arrangement as described above, but of course, it is possible to arrange the input device set shown in FIGS. 4a and 4c as well as the input sets shown in FIGS. 4b and 4d in the vertical or horizontal direction.

As described above, in case where the input device set is provided two in number, the movement directions of the contact point passing through the reference position indicating section 30 may be provided four in number.

Also, in the above case, the sensing section 20 (including the touch pad 21 or the touch screen 23) further includes a depression sensing section so as to enable a multi-stage input operation to be performed by the touching or depression of each direction indicating section 50 by the contact point. In this case, consonant characters may be inputted through the leftward and rightward movement of the contact point at each direction indicating section 50 and vowel characters may be inputted through the touching or depression of each direction indicating section 50 by the contact point.

In the meantime, in case where an auxiliary direction indicating section 51 is provided, vowel characters may be inputted through one of the touching (contact) or depression of each direction indicating section 50 by the contact point, and the movement of the contact point at each direction indicating section 50 or the movement of the contact point passing through the reference position indicating section 30, and various functional commands such as enter, space, cancel, etc., may be inputted through the other movement.

The input device 1 may be replaced with a mouse. For example, when a user manipulates a switch key 13 provided at the base 10 or performs the input operation on the touch screen 23 to switch the operation mode from the character input mode to a mouse input mode, a mouse function can be performed through the touching or the movement of the contact point at the input region 25.

In other words, the movement of a mouse pointer can be performed by the movement of the contact point and a function of a left button of the mouse can be performed by the touching.

In this case, the left button of the mouse includes typically functions such as depression of left and right buttons or the vertical scrolling performed in an input device called a ‘mouse’ used in a desktop PC or a notebook PC.

In this case, particularly, as shown in FIG. 3b(d) and 3b(e), the scrolling function may be performed through the input operation based on the circumferential movement of the contact point.

Meanwhile, as shown in FIG. 6b, the reference position indicating section 30 are provided in two sets at the right and left sides of the upper portion of the touch screen 23, the input device set at the right side of the touch screen can manipulate a pointer function of a joystick, i.e., the movement of a game character, and the input device set at the left side of the touch screen can input commands for performing various motions of the character.

In case of the movement of the game character, if the contact point in close Contact with the input region 25 goes far away from the reference position indicating section 30, it is possible to increase the movement speed of the pointer or the game character.

In the meantime, the reference position indicating section 30 may be provided on the input region 25 such that it can be moved in a specific direction on the input regions 25. That is, as shown in FIG. 7a, the reference position indicating section 30 can be moved on the touch screen 23 in a state where a user touches any one of the reference position indicating section 30, the direction indicating section 50 and the direction indicator 55.

In this case, for example, when the user touches the reference position indicating section 30 one time, the direction is inputted. When the user touches the reference position indicating section 30 more than two times within a predetermined time, the reference position indicating section 30 can be moved.

Here, the reference position indicating section 30, the direction indicating section 50 and the direction indicator 55 are configured in such a fashion as to be moved in the same direction in response to the contact movement thereof by the user.

Also, as shown in FIG. 7a, when the user moves the reference position indicating section 30 or the direction indicator 55 by touching, the reference position indicating section 30 can be moved to the inside of the standby region 26. At this time, the reference position indicating section 30, the direction indicating section 50 and the direction indicator 55 can be displayed in the form of a moving point 31 on the touch screen 23.

In other words, the reference position indicating section 30, the direction indicating section 50 and the direction indicator 55 are maintained in the form of a moving point 31 inside the standby region 26. The reference position indicating section 30, the direction indicating section 50 and the direction indicator 55 may be configured such that when the user touches the moving point 31 positioned inside the standby region 26 to move it to the outside of the standby region 26, they are re-displayed in the form of an original input device on the touch screen 23.

In the meantime, as shown in FIG. 7b, the reference position indicating section 30 may be displayed in the form of a small point so as to indicate a positional reference on the touch screen. The form of the small point is defined as a term including a circle and a polygon, which is implemented to serves as a reference to allow the user to identify it.

In the input device of the touch screen type, the reference position indicating section 30 is implemented in the form of a small point which the user can recognize and the direction indicators 33 of the reference position indicating section 30 can be displayed transparently. Also, the input operation is performed and simultaneously the screen is identified, so that a separate space for the input is not needed on the screen, and hence the screen can be more efficiently utilized.

### Embodiment 2

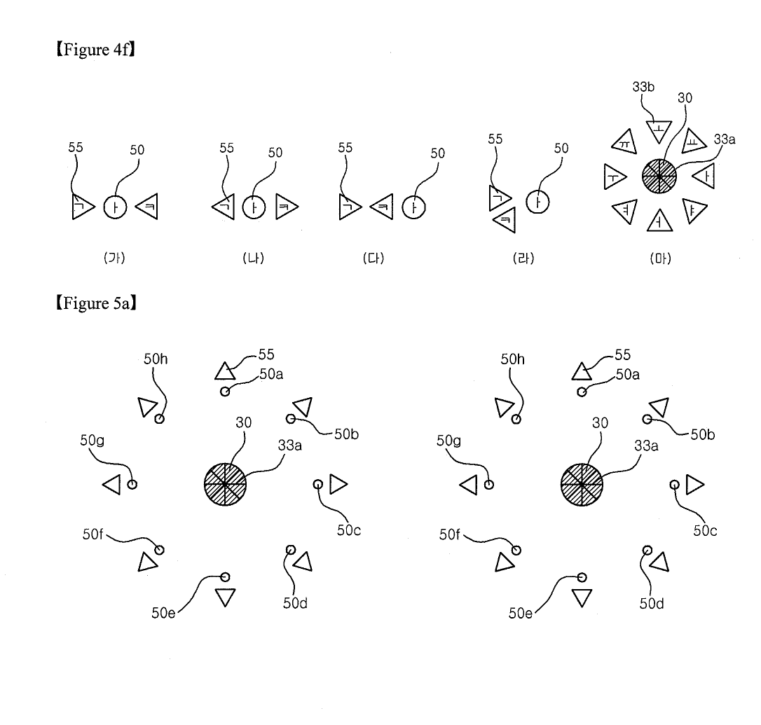

An input device according to a second embodiment of the present invention will be described hereinafter with reference to FIG. 4b, and FIGS. 8 to 10. The elements of the second embodiment corresponding to those of the first embodiment are denoted by the same reference numerals as those denoting the elements used in the first embodiment.

In this embodiment, the sensing section 20, as shown in FIG. 1b(c), includes a plurality of sensing lines 20e and 20f for separating the inward contact movement and the outward contact movement from each other. The sensing lines 20e and 20f may be formed in the shape of a circular strip along a circumferential path of the input region as shown in FIG. 1b(c).

When the sensing lines 20e and 20f are touched or the touch is released from the input region simultaneously, the control section recognizes it as the touch-based input operation. When the sensing lines 20e and 20f are touched or the touch is released sequentially outwardly from a reference position 30a, the control section recognizes it as the outward contact movement-based input operation. On the contrary, when the sensing lines 20f and 20e are touched or the touch is released sequentially inwardly toward the reference position 30a, the control section recognizes it as the inward contact movement-based input operation

In this case, the sensing lines 20e and 20f are not limited in the kind thereof as long as they can detect the contact of a user's finger or an input object like an optical sensor, a capacitance sensor, a pressure sensor, a contact (or touch) sensor. The sensing lines 20e and 20f may be provided in plural numbers.

The sensing section 20 shown in FIG. 1b(c) will be described hereinafter in more detail.

Eight direction sensing lines 20g are disposed equidistantly at different circumferential positions spaced apart radially outwardly from the reference position 30a. An inner sensing line 20e and an outer sensing line 20f are positioned at the inside and outside of the direction sensing lines 20g, respectively, so as to grasp a sequence in which the sensing lines 20e and 20f are touched or the touch is released.

A touch sensing signal is generated when the direction sensing lines 20g are touched or the inner sensing line 20e and the outer sensing line 20f are touched simultaneously along with the direction sensing lines 20g. Alternatively, the touch sensing signal is generated when the touch of any one of the inner sensing line 20e and the outer sensing line 20f is detected within a predetermined time along with the touch of the direction sensing lines 20g.

An outward contact movement sensing signal is generated when the inner sensing line 20e, the direction sensing lines 20g and the outer sensing line 20f are touched sequentially in this order outwardly from the reference position 30a. Also, an inward contact movement sensing signal is generated when the outer sensing line 20f, the direction sensing lines 20g and the inner sensing line 20e are touched sequentially in this order inwardly toward the reference position 30a.

Input sections 60 are provided on the sensing section 20. As shown in FIG. 8, each of the input section 60 includes a plurality of input objects 61, 62 and 63. A first input target 61 of the input section 60 is assigned with first consonants [symbol] and [symbol] as first characters. When the first input target assigned with the first characters is touched, the first characters are recognized by the sensing section 20. A second input target 62 of the input section 60 is assigned second consonants [symbol] and [symbol] with as second characters so that the inward contact movement-based input operation is performed. A third input target 63 of the input section 60 is assigned with vowels [symbol] and [symbol] as third characters so that the inward contact movement-based input operation is performed. It is to be noted that the arrangement of the consonants and vowels is not limited to the above arrangement, but can be modified variously for the sake of a user's convenience.

In the input device 1 of this embodiment, the input section 60 features that it has the shape of an annular ring in its entirety.

In the input section 60 having the above feature, the input targets 61, 62 and 63 is further provided with a depression-based input function which is performed when depressed with a pressure more than a predetermined pressure along with a touch. Since the character input operation can be performed through the touch and the depression of the input targets 61, 62 and 63, an input capacity can be further increased. The depression-based input function is provided by a typical input key or pressure sensor which allows a character to be inputted through depression of the input targets 61, 62 and 63. In this case, the touch-based input operation performed prior to the depression-based input operation can be ignored or a touch sensing signal and a depression sensing signal can be combined so as to perform the depression-based input operation.

Referring back to FIG. 8, each of the input targets 61, 62 and 63 provided on the input section 60 has a direction indicating symbol so that a user can easily perform both the inward contact movement and the outward contact movement of the input targets 61, 62 and 63. That is, the second input target 62 has a symbol [symbol] indicating an inward contact movement direction, and the third input target 63 has a symbol [symbol] indicating an outward contact movement direction. Also, the first input target 61a symbol [symbol] indicating a touch-based input operation, which have no specific directionality. The symbols can be indicated in the form of another symbol or color for separating input directions from each other.

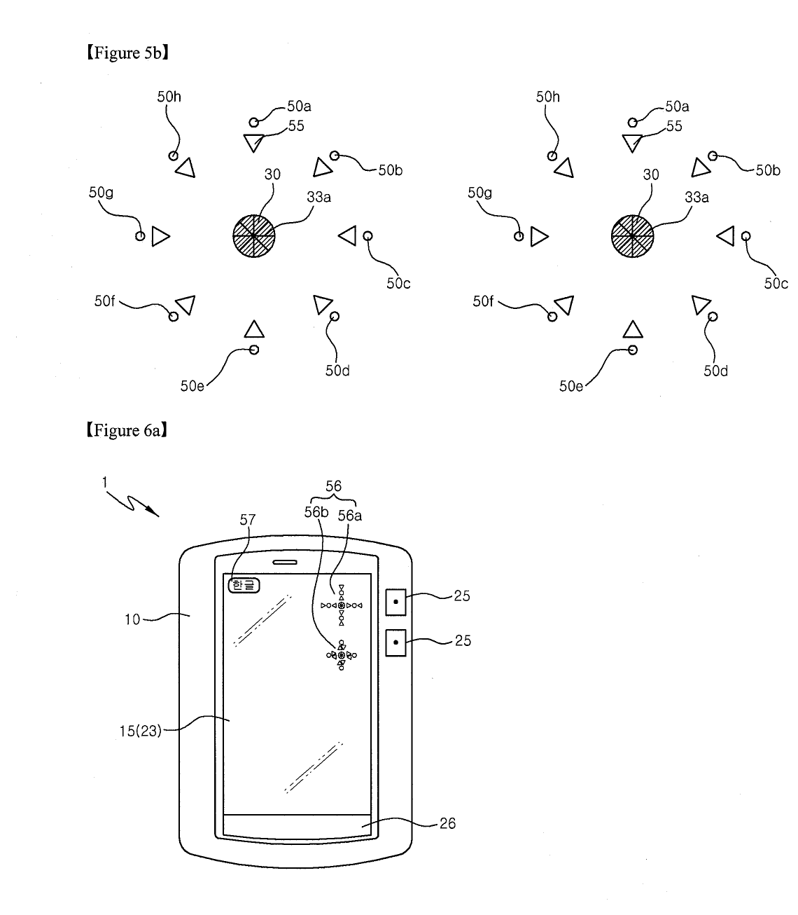

Meanwhile, in the input device, when the contact with the input section 60 and the contact movement are performed continuously, a circumferential contact movement-based input operation (see FIG. 9b(3)) can be performed so as to progress the input operation without any interruption of the operation

During the circumferential contact movement-based input operation, the input operation is performed in a circumferential direction. At this time, although the touch of a plurality of input targets 61, 62 and 63 are detected, the control section processes the first input operation and the last input operation as valid input operations. The last input operation can be grasped when a sensing signal is released or the input operation is maintained for a predetermined time at the same position at the time of the completion of the contact movement-based input operation.

Various modifications of the input operation of the input device according to the second embodiment will be described hereinafter in detail with reference to FIGS. 9(a) and 9(b).

FIG. 9(a) shows a process in which a character is inputted through the touch-based input operation, the outward contact movement-based input operation and the inward contact movement-based input operation.

More specifically, first, when a user touches the input section 60 as indicated by \textcircled{1}, a character [symbol] assigned to the first input target 61 provided on the input section 60 is selected. Then, when the outward contact movement-based input operation is performed as indicated by \textcircled{2}, a character [symbol] assigned to the third input target 63 provided on the input section 60 is selected. Next, when the inward contact movement-based input operation is performed as indicated by \textcircled{3}, a character [symbol] assigned to the second input target 61 provided on the input section 60 is selected. Thus, the three input operations are performed sequentially to thereby complete one Hangeul syllable character

[symbol]

FIG. 9(b) shows a process in which a character is inputted through the outward contact movement-based input operation, the inward contact movement-based input operation and the circumferential contact movement-based input operation.

More specifically, first when the inward contact movement-based input operation is performed as indicated by \textcircled{1}, a character [symbol] is selected which is assigned to the first input target 61 provided on the input section 60 positioned in the direction of the hour hand of the clock showing 12 o'clock. Then, a character [symbol] is selected which is assigned to the third input target 63 provided on the input section 60 positioned in the direction of the hour hand of the clock showing six o'clock as indicated by \textcircled{2}. Next, the contact point is moved circumferentially in the clockwise direction and the input section 60 positioned in the direction of the hour hand of the clock showing 10 o'clock is touched as indicated by \textcircled{3}. Thereafter, when the touch is released or is stopped for a predetermined time, characters [symbol] and [symbol] which have been touched in the course of the circumferential contact movement are not inputted but a character [symbol] is selected which is assigned to the first input target 61, i.e., the last input position positioned in the direction of the hour hand of the clock showing 10 o'clock. Thus, the three input operations are performed sequentially to thereby complete one. Hangeul syllable character

[symbol]

In this case, the input operation may be configured such that only when the last input operation is released, a character [symbol] being touched is inputted, and when the last input operation is released through the inward contact movement, an inward contact movement character [symbol] is inputted. Also, the input operation may be configured such that when the last input operation is released through the outward contact movement, an outward contact movement character [symbol] is inputted.

During the circumferential contact movement-based input operation, a method of recognizing a circumferential contact movement of the contact point by a user can be variously implemented. The operation the circumferential contact movement-based input operation may be recognized through an arrangement of a terminal for detecting the circumferential contact movement-based input operation between the respective input targets, or may be recognized when prior to the release of a sensing signal upon the circumferential contact movement-based input operation other sensing signals are continuously detected.

Alternatively, the circumferential contact movement-based input operation may be recognized when the characters assigned to the respective input targets 61, 62 and 63 are continuously inputted during the circumferential contact movement-based input operation.

FIG. 9(c) shows a process in which a character is inputted through the outward contact movement-based input operation and the inward contact movement-based input operation.

More specifically, first when the inward contact movement-based input operation is performed as indicated by \textcircled{1}, a character [symbol] is selected which is assigned to the second input target 62 provided on the input section 60 positioned in the direction of the hour hand of the clock showing one o'clock. Then, a character [symbol] is selected which is assigned to the third input target 63 provided on the input section 60 positioned in the direction of the hour hand of the clock showing 12 o'clock through the outward contact movement of the contact point as indicated by \textcircled{2}. Next, a character [symbol] is selected which is assigned to the second input target 62 provided on the input section 60 positioned in the direction of the hour hand of the clock showing 12 o'clock through the inward contact movement of the contact point as indicated by \textcircled{3}. Thus, the three input operations are performed sequentially to thereby complete one Hangeul syllable character [symbol] In this case, since the input operation is performed by a single continuous motion, a character can be more easily and rapidly inputted.

FIG. 9(d) shows a process in which a character is inputted through the touch-based input operation, the outward contact movement-based input operation, the inward contact movement-based input operation and the circumferential contact movement-based input operation.

More specifically, first, when a user touches the input section 60 positioned in the direction of the hour hand of the clock showing nine o'clock as indicated by \textcircled{1}, a character [symbol] assigned to the first input target 61 provided on the input section 60 is selected. Then, when the outward contact movement-based input operation is performed toward the input section 60 positioned in the direction of the hour hand of the clock showing three o'clock as indicated by \textcircled{2}, a character [symbol] assigned to the third input target 63 provided on the input section 60 is selected. Next, the contact point is moved circumferentially in the clockwise direction from the input section 60 positioned in the direction of the hour hand of the clock showing three o'clock and then the input section 60 positioned in the direction of the hour hand of the clock showing six o'clock is touched as indicated by \textcircled{3}. Thereafter, when the contact point is moved inwardly at the input section 60 positioned in the direction of the hour hand of the clock showing six o'clock, a character [symbol] is selected which is assigned to the second input target 62 provided on the input section 60. Thus, the three input operations are performed sequentially to thereby complete one Hangeul syllable character [symbol] .

FIG. 9(e) shows a process in which a character is inputted through the touch-based input operation, the circumferential contact movement-based input operation, the inward contact movement-based input operation.

More specifically, first, when a user touches the input section 60 positioned in the direction of the hour hand of the clock showing twelve o'clock as indicated by \textcircled{1}, a character [symbol] assigned to the first input target 61 provided on the input section 60 is selected through the touch-based input operation. Then, the contact point is moved circumferentially in the counter-clockwise direction to the input section 60 positioned in the direction of the hour hand of the clock showing nine o'clock and then the input section 60 is touched. At this time, when the contact point is moved inwardly, a character ‘—’ is selected which is assigned to the second imputer target 62 provided on the input section 60 positioned in the direction of the hour hand of the clock showing nine o'clock. Next, when the contact point is moved to the input section 60 positioned in the direction of the hour hand of the clock showing five o'clock and the input section 60 is touched as indicated by \textcircled{3}, a character [symbol] is selected which is assigned to the first imputer target 61 provided on the input section 60 through the touch-based input operation. Thus, the three input operations are performed sequentially to thereby complete one Hangeul syllable character

[symbol]

The input device 1 may allow a character to be inputted through a manipulation of each input target based on the one-operation and one phoneme input principle (contact, inward contact movement, outward contact movement), but may allow a plurality of phonemes to be inputted on a basis of one operation (contact+inward contact movement+outward contact movement) as shown in FIGS. 9a and 9e.

Like this, the input device may be configured such that at least two of the touch-based input operation, the inward contact movement-based input operation, the outward contact movement-based input operation and the circumferential contact movement-based input operation are detected as a one continuous input operation, the control section determines that each character is inputted and then processes the input operation.

In this case, the one continuous input operation refers to an input operation in which more than two input operations are not performed separately, but subsequent input operations are performed continuously at a time without completing each input operation after the first input operation

In the input device according to this embodiment, the input section 60 may be provided two in number. The input device includes two input sections 60 so that a touch sensing signal, an inward contact movement sensing signal and an outward contact movement sensing signal generated from the respective input targets 61, 62 and 63 can be increased as high as double to thereby arrange much more characters on the input region. Also, the input device may include two input sections so that they arrange the characters which are the same in number as those arranged in a single input section in four directions, respectively.

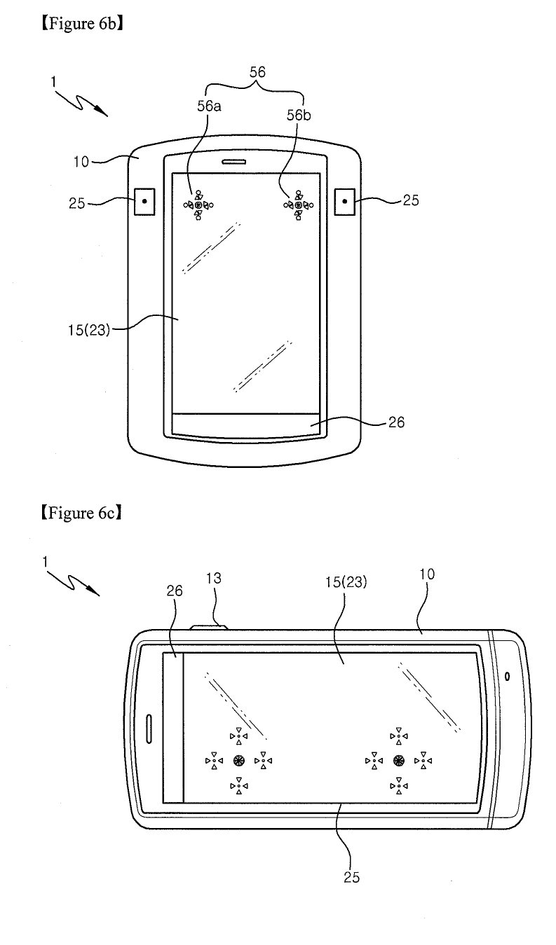

Referring to FIGS. 10(a) and 10(b), the input section 60 has the shape of an annular ring formed integrally in its entirety. The input section 60 may include an input target to which a press function is added, and four extension keys 65 at the inside or outside thereof for enabling a touch or a press. The extension keys 65 may include characters or various functional commands such as OK, cancel, menu and the like arranged thereon

### Embodiment 3

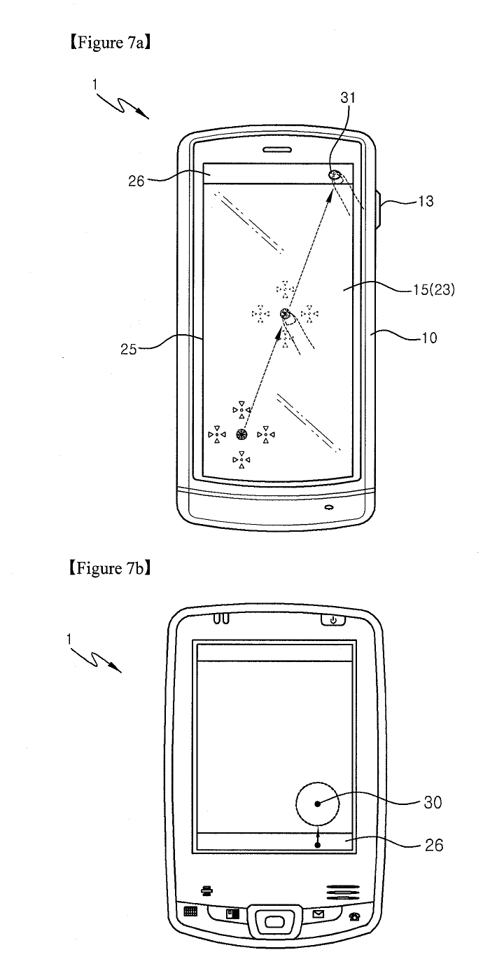

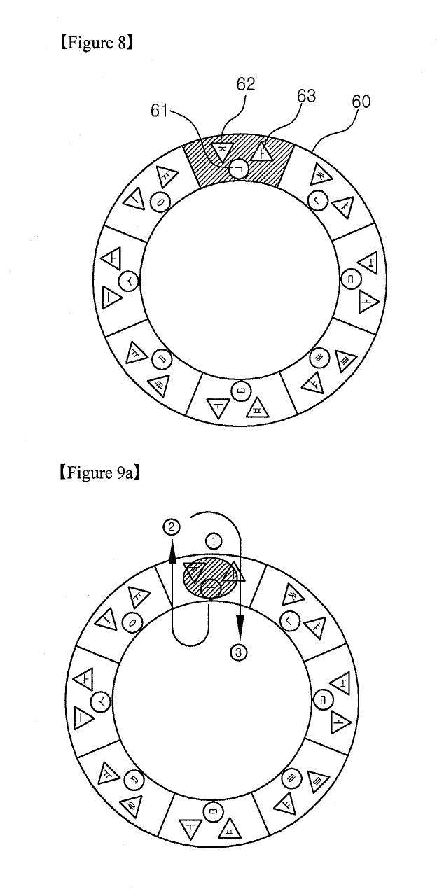

Now, an input device according to a third embodiment of the present invention will be described hereinafter with reference to FIGS. 11 and 12. The elements of the second embodiment corresponding to those of the first and second embodiments are denoted by the same reference numerals as those denoting the elements used in the first and the second embodiments.

As shown in FIG. 11, the input section 60 according to this embodiment includes a first input section 60a positioned at an inner side and a second input section 60b. A first input target 61 is included in the first input section 60a, a second input target 62 is included in the second input section 60b, and a third input target 63 is included at a boundary portion between the first and second input sections 60a and 60b.

In this case, a first character is assigned to the first input target 61, and a second input target 62 is assigned to the second input target 62. The first input target 61 and the second input target 62 are arranged in such a fashion as to be oriented toward the center of the annular ring-shaped input section so as to be selected by the inward contact movement-based input operation. Meanwhile, a third character is assigned to the third input target 63, and is oriented toward the outside of the annular ring-shaped input section so as to be selected by the outward contact movement-based input operation.

In this embodiment, when the first input target 61 provided on the first input section 60a is touched or the inward contact movement-based input operation is performed, the first character assigned to the first input target 61 is inputted. Also, when the second input target 62 provided on the second input section 60b is touched or the inward contact movement-based input operation is performed, the second character assigned to the second input target 62 is inputted.

In this case, the inward contact movement-based input operation is performed on the second input target 62, and simultaneously the inward contact movement-based input operation can be performed on the first input target 61. At this time, the determination whether which one of the two input targets will be selected is made based on the movement distance of the contact point detected by the sensing section 20 provided on a portion corresponding to the input section 60 at the time of the inward contact movement-based input operation. That is, the movement distance of the contact point going out of the first input section 60a after the contact point has been moved inwardly in a state where the first input target 61 is touched, is compared with the movement distance of the contact point going out of the first input section 60a after the contact point has been moved inwardly in a state where the second input target 62 is touched. As a result, since the distance of the contact point moved from the second input target 62 is greater than that of the contact point moved from the first input target 61, a determination whether which one of the two characters assigned to the first input target 61 and the second input target 62 will be inputted is made based on a difference in the movement distances of the contact point.

In addition, the third input target 63 is selected by only the outward contact movement of the contact point. Thus, although the touch-based input operation or the inward contact movement-based input operation is performed on the third input target 63, any character assigned to the third input target 63 is not inputted.

In the meantime, although this embodiment has described that the first to third j input targets 61, 62 and 63 are provided circumferentially only in four directions, they may be, of course, provided in various directions extended such as six directions, eight directions or the like. Besides, an input device having the first to third input targets 61, 62 and 63 provided in four directions may be included in a total of two sets so as to extend the number of characters which can be inputted.

The input operation of the input device according to the third embodiment will be described hereinafter in detail with reference to FIG. 12.

As shown in FIG. 12(a), in order to input a Hangeul syllable character [symbol] when a user first touches the second input target 62 or moves the contact point inwardly on the second input target 62 as indicated by \textcircled{1}, a character [symbol] assigned to the second input target 62 is selected. In this case, when the inward contact movement-based input operation is performed, although the contact point is moved inwardly while passing through the first input target 61 assigned with a character [symbol] the character [symbol] assigned to the second input target 62 causing a relatively great movement distance is selected due to a difference in the movement distances of the contact point passing through the first and second input sections 60a and 60b.

Subsequently, the user moves the contact point outwardly as indicated by \textcircled{2} so as to input a character

[symbol]

Thereafter, the user moves the contact point circumferentially toward the second input target 62 provided on the second input section 60b as indicated by \textcircled{3} so as to select a character [symbol] assigned to the second input target 62. In this case, the second input target 62 is maintained for a predetermined time in a state where the second input target 62 is touched or the inward contact movement-based input operation is performed on the second input target 62 in order to input the character

[symbol]

In the meantime, as shown in FIG. 12(b), in order to input a Hangeul syllable character [symbol] when a user first touches the first input target 61 or moves the contact point inwardly on the first input target 61 as indicated by \textcircled{1}, a character [symbol] assigned to the first input target 61 is selected. Subsequently, the user moves the contact point outwardly as indicated by \textcircled{2} so as to input a character [symbol] assigned to the third input target 63. Thereafter, the user moves the contact point circumferentially toward the first input target 61 provided on the first input section 60a as indicated by \textcircled{3} so as to select a character [symbol] assigned to the first input target 61. In this case, the first input target 61 is maintained for a predetermined time in a state where the second input target 62 is touched or the inward contact movement-based input operation is performed on the first input target 61 in order to input the character [symbol] .

In FIGS. 12(a) and 12(b), any other input target is not touched between the first input and the last input when the contact point is moved circumferentially. In this case, if a specific input target is touched between the first input and the last input, a character to be inputted can be determined by the circumferential contact movement-based input operation as in the first and second embodiments.

### Embodiment 4

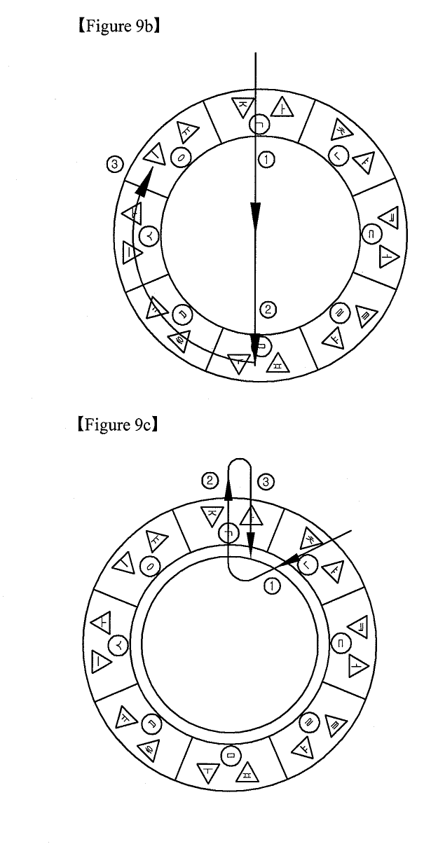

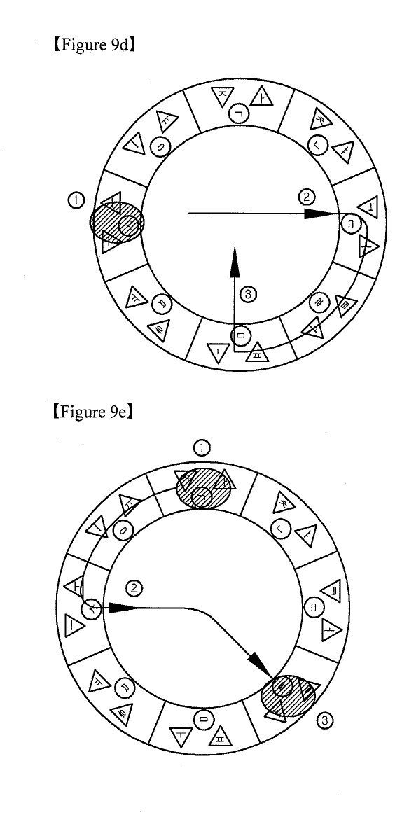

Now, an input device according to a fourth embodiment of the present invention will be described hereinafter with reference to FIGS. 13 and 14. The elements of the fourth embodiment corresponding to those of the first to third embodiments are denoted by the same reference numerals as those denoting the elements used in the first to third embodiments.

In this embodiment, there is described a character input method in which a character is inputted through a touch-based multi-stage input operation. Herein, the touch-based multi-stage input operation refers to a character input scheme in which if a pressure more than a predetermined pressure level is detected for a predetermined time after touching a region on the sensing section 20 on which two characters are displayed, the control section determines the input operation as the touch-based multi-stage input operation and inputs either of the two characters.

That is, as shown in FIG. 13, the input section 60 includes a first input section 60c having the shape of an annular ring and a second input section 60d provided inside the first input section 60c. Also, the first input section 60c includes a first input target 61 and a second input target 62 which are assigned with two Hangeul consonants, respectively, and the second input section includes a third input target 63 and a fourth input section 64 which are assigned with two Hangeul vowels, respectively.

In this case, the first input target 61 and the second input target 62 adopts a method in which a character is inputted though the touch-based multi-stage input operation. Thus, if the user simultaneously touches the first input target 61 and the second input target 62 which are assigned with characters [symbol] and [symbol] respectively, with a pressure less than a predetermined pressure, the character [symbol] is inputted. At this time, if the first input target 61 and the second input target 62 are simultaneously touched with a pressure more than a predetermined pressure, the character [symbol] is inputted. In this case, the first and second input targets 61 and 62 have a direction indicator for indicating that a character is inputted through the inward contact movement-based input operation in FIG. 13, so that a specific character can be inputted only by the strength of the touch. Also, if the contact point is moved inwardly on the first and second input targets 61 and 62a in a state where they are touched, a specific character can be inputted by the strength of the touch. That is, a combination of the inward contact movement-based input operation and the touch-based multi-stage input operation enable a character to be inputted.

In the meantime, in case of the characters [symbol] and [symbol] assigned to the third input target 63 and the fourth input section 64, respectively, either of the two characters can be determined depending on the strength of the touch during the outward contact movement-based input operation. That is, the third input target 63 and the fourth input section 64 adopts a method in which a character is inputted though a combination of the outward contact movement-based input operation and the touch-based multi-stage input operation. Thus, in this embodiment, if the user moves the contact point outwardly while simultaneously touching the third input target 63 and the fourth input section 64 with a pressure less than a predetermined pressure, the character [symbol] assigned to the third input target 63 is inputted. At this time, if the third input target 63 and the fourth input section 64 are simultaneously touched with a pressure more than a predetermined pressure, the character [symbol] assigned to the fourth input target 64 is inputted.

Meanwhile, the input device of this embodiment adopts a construction in which the first input section 60c includes the first input target 61 and the second input target 62 which are assigned with consonant characters, and the second input section 60d includes the third input target 63 and the fourth input section 64 which are assigned with vowel characters, but the arrangements of the first to fourth input targets 61, 62, 63 and 64 are not limited thereto. Also, although this embodiment describes that the first to fourth input targets 61, 62, 63 and 64 are provided in only four directions, it is possible to extend the arrangement direction of the input targets variously such as six directions, eight directions or the like.

In addition, four extension keys 65 are further provided at the outside of the input section 60. The extension keys 65 are provided so as to input OK, cancel, space bar and the like. Thus, an extension key input sensing sections (not shown) are further included at portions where the extension keys 65 are provided so as to detect any contact with the extension keys 65.

In this case, the extension keys 65 may be provided at the center of the second input section 60d.

The input operation of the input device according to the fourth embodiment will be described hereinafter in detail with reference to FIG. 14.

As shown in FIG. 14, in order to input a Hangeul syllable character [symbol] a user first simultaneously touches the first and second input targets 61 and 62 which are assigned with characters [symbol] and [symbol] respectively, or touch only the second input target 62 assigned with the character [symbol] as indicated by \textcircled{1}. In this case, when the user simultaneously touches the first and second input targets 61 and 62 with a pressure less than a predetermined pressure, the character [symbol] assigned to the first input target 62 is selected. In one embodiment, the first and second input targets 61 and 62 must be depressed with a pressure more than a predetermined pressure. Alternatively, the contact point may be moved inwardly on the first and second input targets 61 and 62 in a state where the first and second input targets 61 and 62 are touched with the pressure more than a predetermined pressure so as to select a the character

[symbol]

Subsequently, the contact point is moved to the second input section 60d as indicated by \textcircled{2} and passes through the third and fourth input targets 63 and 64. At this time, the selection of a character is made by though a combination of the outward contact movement-based input operation and the touch-based multi-stage input operation, so that since the third and fourth input targets 63 and 64 through which the contact point passes are opposite in the movement orientation direction of the contact point for the input to the first and second input targets 61 and 62, neither of the two characters [symbol] and [symbol] is inputted. Then, either of the characters [symbol] and [symbol] is selected which is assigned to the third and fourth input targets 63 and 64 through which the contact point passes during the outward movement of the contact point. In this case, either of the two characters [symbol] and [symbol] is selected depending on the strength of the touch upon the movement of the contact point passing through the third and fourth input targets 63 and 64. In one embodiment, since the character [symbol] assigned to the third input target 63 must be selected, the contact point should pass through the third and fourth input targets 63 and 64 with a pressure less than a predetermined pressure.

Thereafter, the user touches the characters [symbol] and [symbol] assigned to the first and second input targets 61 and 62 positioned in the direction of the hour hand of the clock showing three o'clock as indicated by \textcircled{3}. In one embodiment, the first and second input targets 61 and 62 must be touched with a pressure less than a predetermined pressure in order to select the character [symbol] or only the first input target 61 must be touched. Alternatively, the contact point may be moved inwardly on the first and second input targets 61 and 62 with a pressure more than a predetermined pressure in a state where the first and second input targets 61 and 62 are touched so as to select the character [symbol] assigned to the first input target 61.

### Embodiment 5

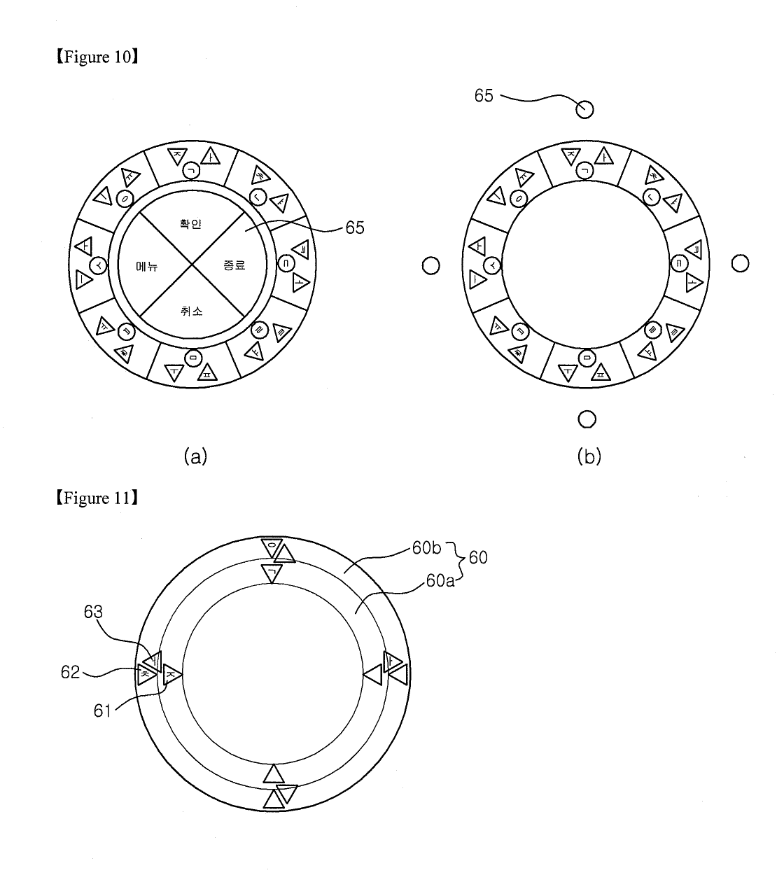

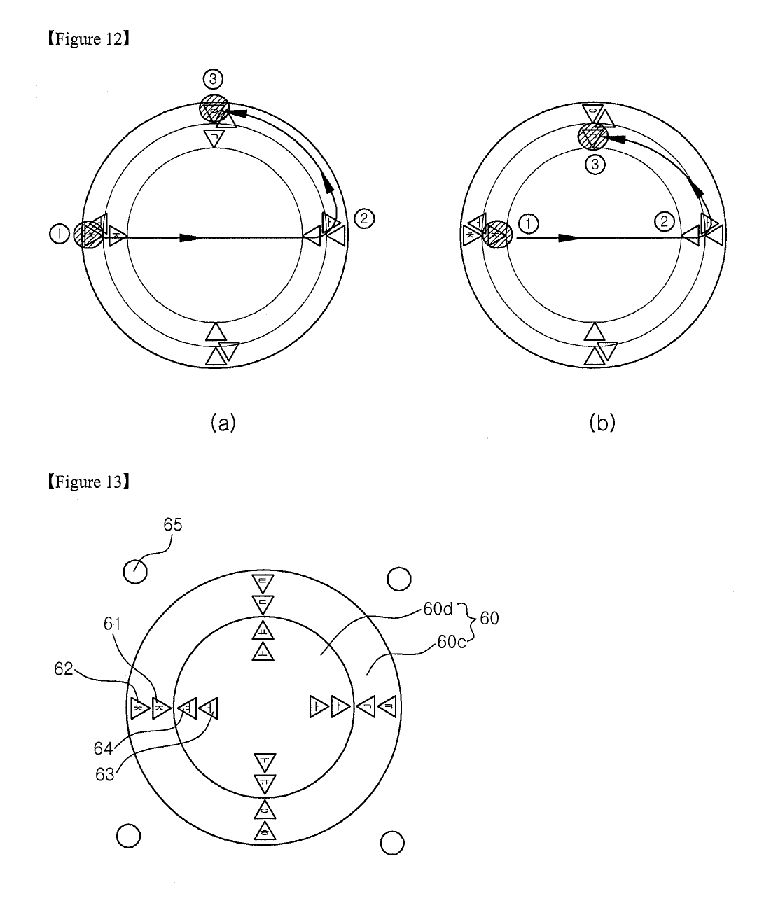

Now, an input device according to a fifth embodiment of the present invention will be described hereinafter with reference to FIGS. 15 and 16. The elements of the fifth embodiment corresponding to those of the first to fourth embodiments are denoted by the same reference numerals as those denoting the elements used in the first to fourth embodiments.

In this embodiment, various modifications of the input operation according to the movement distance of the contact point are illustrated.

More specifically, as shown in FIG. 15, an input section 20 according to this embodiment includes a first input section 60e provided at the central portion thereof, a second input section 60f provided at the outer circumferential portion of the first input section 60e and having an annular ring shape, and a third input section 60g provided at outer circumferential portion of the second input section 60f and having an annular ring shape. Also, the first input section 60e includes four input targets 61 that indicate the direction of the outward contact movement-based input operation.

In addition, in this embodiment, the sensing section 20 may be provided at portions corresponding to the first to third input sections 60e, 60f and 60g.

In this case, each of four characters [symbol] and [symbol] assigned to the four input targets 61, respectively, can be inputted as it is immediately during the touch-based input operation, but may be inputted as characters [symbol] and [symbol] through an outward contact movement-based multi-stage input operation.

Herein, the outward contact movement-based multi-stage input operation refers to a character input scheme in which in case where a movement displacement level more than a predetermined value is detected by the sensing section 20 when the contact point is moved to input a specific character, the control section determines the input operation as the outward contact movement-based multi-stage input operation and inputs the specific character.

That is, in FIG. 16(a), when a user touches the input target 61 assigned with a character [symbol] as indicated by \textcircled{1}, the character [symbol] is inputted. Then, when the contact point is moved to outwardly to a position indicated by \textcircled{2} after completely passing through the second and third input sections 60f and 60g in a state where the input target 61 is touched, a character [symbol] is inputted.

In FIG. (b), when a user moves the contact point outwardly in a state of touching the input target 61 assigned with a character [symbol] and the movement of contact point is stopped or the touch is released at the second input section 60f as indicated by \textcircled{1}, the character [symbol] is inputted. Then, when the contact point is moved to outwardly to the third input section 60g as indicated by \textcircled{2} in a state where the input target 61 is touched, a character [symbol] is inputted.

Also, in FIG. 16(c), when the user touches the input target 61 assigned with a character [symbol] the character [symbol] is inputted. Then, when the contact point is moved to outwardly to a position indicated by \textcircled{2}, i.e., the inside of the second and third input sections 60f and 60g in a state where the input target 61 is touched, a character [symbol] is inputted.

Further, in FIG. 16(d), when a user moves the contact point outwardly to a position indicated by \textcircled{1}, i.e., the inside of the second and third input sections 60f and 60g in a state of touching the input target 61 assigned with a character [symbol] the character [symbol] is inputted. Then, when the contact point is moved outwardly from the third input section 60g, a character [symbol] is inputted.

Although this embodiment has shown only four input targets 61, the number of input targets 61 is not limited thereto, and other input schemes different from the input scheme can be combined so as to implement various modifications of the input operation.

### Embodiment 6

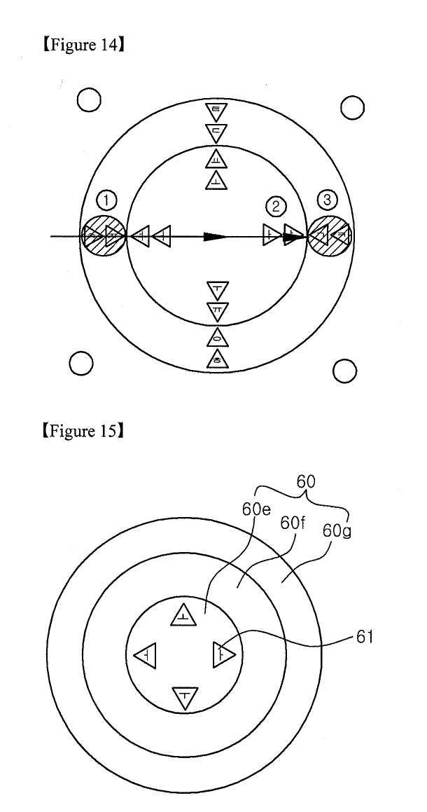

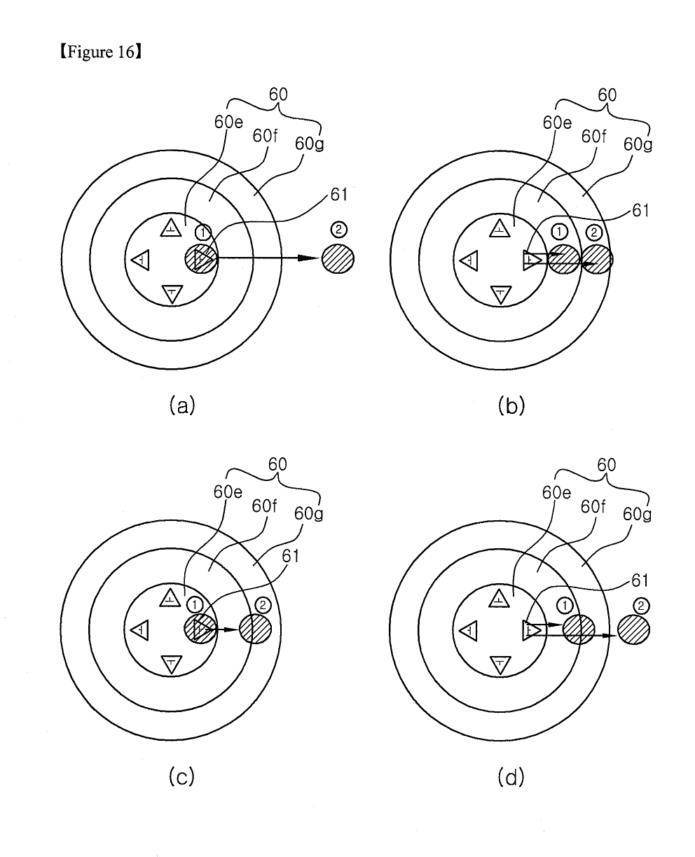

Now, an input device according to a sixth embodiment of the present invention will be described hereinafter with reference to FIGS. 17 and 18. The elements of the sixth embodiment corresponding to those of the first to fifth embodiments are denoted by the same reference numerals as those denoting the elements used in the first to fifth embodiments.

Referring to FIG. 17, the input section 60 includes first to fourth input targets 61, 62, 63 and 64 which are assigned with a first consonant, a second consonant, a first vowel and a second vowel, respectively, at each radial position. The first and second consonants can be inputted through the touch-based multi-stage input operation or the inward contact-based multi-stage input movement operation, and the first and second vowels can be inputted through the outward contact-based multi-stage movement input operation.

Herein, the inward or outward contact-based multi-stage movement input operation refers to a character input scheme in which a character is inputted by dividing a multi-stage input operation depending on the strength of the touch of the input section when the contact point is moved to input a specific character.

In the meantime, the first and second vowels can also be inputted through only the outward contact movement-based multi-stage input operation. The outward contact movement-based multi-stage input operation refers to a character input scheme in which a character is inputted by dividing a multi-stage input operation depending on the movement distance of the contact point. In one embodiment, as showing in FIG. 18, in case where a character [symbol] assigned to the third input target 63 is selected through the outward movement of the contact point, the movement of the contact point must be stopped on the third input target 63 or the touch of the third input target 63 must be released during the outward movement of the contact point. In one embodiment, when it is desired to select a character [symbol] assigned to the fourth input target 64, the contact point must be moved outwardly so as to allow the fourth input target 64 to be touched while passing through the input section 60 via the third input target 63

### Embodiment 7

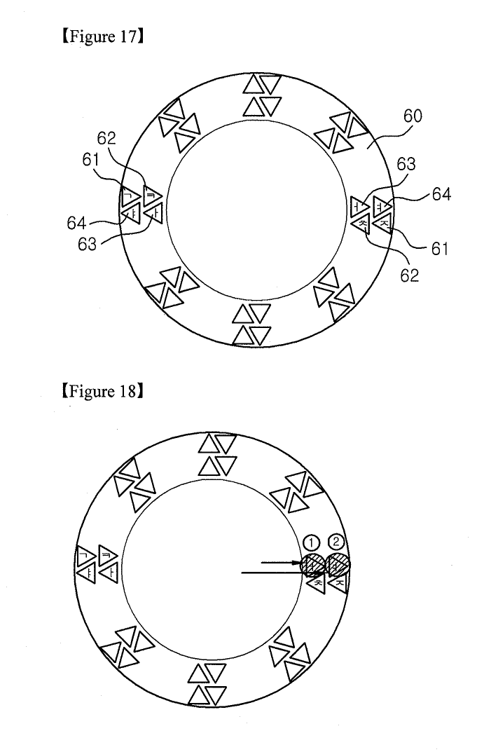

Now, an input device according to a seventh embodiment of the present invention will be described hereinafter with reference to FIGS. 19 to 21. The elements of the seventh embodiment corresponding to those of the first to sixth embodiments are denoted by the same reference numerals as those denoting the elements used in the first to six embodiments.

This embodiment illustrates the case where the input section is provided in the form of an input key on the touch screen. That is, as shown in FIGS. 19(a) and 19(b), the input section includes a first input section 60h used as a reference and second input sections 60i which are arranged around the first input section 60h in four radial directions.

The second input sections 60i shown in FIG. 19(a) enables an inward contact movement-based multi-stage input operation in which arrows being indicated are oriented inwardly toward the first input section 60h, an outward contact movement-based multi-stage input operation in which arrows being indicated are oriented outwardly from the first input section 60h, and a touch-based input operation, so that a total of five input operations can be performed. Also, the second input sections 60i are provided in four directions, respectively, so that a total of eight input operations can be performed through the second input sections 60i.

Meanwhile, the first input sections 60h shown in FIG. 19(b) enables the touch-based input operation and the multi-stage input operation in the east, west, south and north directions, so that a total of nine input operations can be performed.

Thus, the combination of the input operations shown in FIGS. 19(a) and 19(b) enables a total of nine input operations through the first input section 60h and a total of 20 input operations through the second input sections 60i, so that a total of 29 input operations can be performed.

In addition, the second input sections 60i can be separated from each other by means of two signals such as touch/press, press/one-stage press/two-stage press or the like to generate a total of eight signals so that data can be inputted using a total of 24 signals. In this case, it is possible to implement the construction in which the first input section 60h is added to the second input sections 60i enabling 24 data inputs.

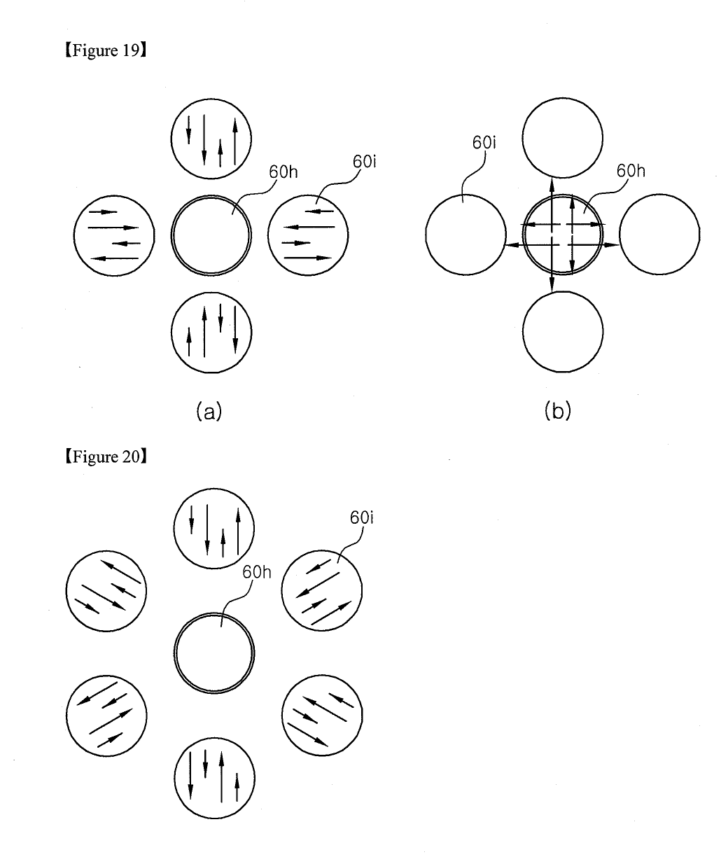

Also, as shown in FIG. 20, the second input sections 60i may be arranged circumferentially in six directions or eight directions around the first input section 60h

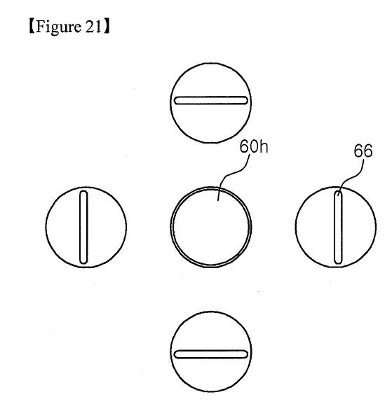

In addition, the input device may be configured such that a projecting section 66 as shown in FIG. 21 is formed on each contact region so that a multi-stage input operation can be performed through the sense of touch for the projecting section by a user during the outward or inward movement of the contact point. If the projecting section 66 is formed, the user can identify the movement direction and movement distance of the contact point even without directly seeing the input device.

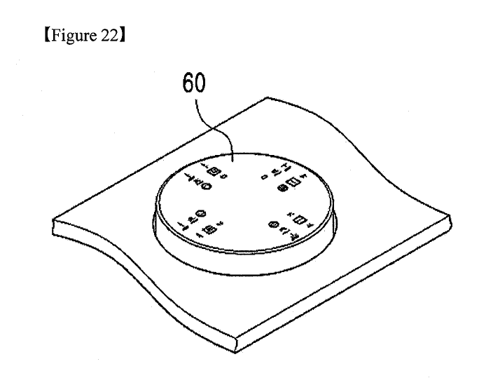

In the meantime, FIG. 22 is an example in which the input section 60 is implemented in the form of a touch pad or a touch key. As shown in FIG. 22, a circular input section 60 is provided on the top surface thereof with a touch sensor for detecting the touch, and the movement of the contact point in the inward, outward, horizontal and vertical directions, etc. In this case, the press function may be used as a functional key such as space, enter, backspace, etc.

According to at least one embodiment, the input device allows all the characters which it is desired to input to be arranged in a minimum input region where a reference position indicating section is disposed as to be suitable for miniaturization, as well as allows each of the arranged characters to be inputted through only one-input operation so as to enable rapid and correct input of a character.

Also, the input device provides an inconvenience of data input owing to a simple configuration and use method based on directionality that anyone can know easily. In addition, since the input device allows three characters to be arranged in one input section so as to be selectively inputted according to a user's intention so that a large amount of data can be inputted in a limited space, it can be applied to various information equipment to thereby accomplish lightness and miniaturization of the information equipment.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1-65. (canceled)

66. An input device comprising:
a sensing section provided at input region and configured to sense contact with the input region or a contact movement to the input region;
a plurality of direction indicating sections disposed equidistantly at different circumferential positions spaced apart radially outwardly from a reference position provided at the input region; and
a control section configured to extract data corresponding to each input operation from a memory and input the extracted data, according to a contact with each direction indicating section detected by the sensing section or the movement direction of the contact point at each direction indicating section.

67. The input device according to claim 66, wherein further comprising a reference position indicating section provided at the reference position and direction indicators provided at one side of at least one of the reference position indicating section and each direction indicating section for indicating each input operation direction according to the movement direction of a contact point performed at the reference position indicating section and each direction indicating section, and
wherein the control section extracts data corresponding to each input operation from the memory and inputs the extracted data, according to the movement direction of the contact point passing through the reference position indicating section.

68. The input device according to claim 67, wherein the input operation is performed in one or more of a fashion that the contact point is contacted with each of the direction indicating sections, a fashion that the contact point is moved radially outwardly from the reference position indicating section toward each of the direction indicating sections, a fashion that the contact point is moved radially inwardly from each of the direction indicating sections toward the reference position indicating section, a fashion that the contact point is moved from any one of the direction indicating sections to another direction indicating section while passing through the reference position indicating section, a fashion that the contact point is moved from each of the direction indicating sections to the tangential direction of a circle having a predetermined radius from the center of the reference position indicating section, a fashion that the contact point is moved in the circumferential direction around the reference position indicating section, a fashion that the contact point is moved in the diagonal direction around the reference position indicating section, a fashion that the contact point is moved forward and rearward at respective direction indicating sections around the reference position indicating section, a fashion that the contact point is moved leftward and rightward at respective direction indicating sections around the reference position indicating section, and a fashion that the contact point is moved in forward/rearward and leftward/rightward at respective direction indicating sections around the reference position indicating section.

69. The input device according to claim 68, wherein the control section inputs the data corresponding to each input operation by separating different signals depending on the movement direction of the contact point at each direction indicating section.

70. The input device according to claim 68, wherein the control section extracts and inputs different characters depending on each direction indicating section which the input operation starts from and ends at, and the direction and the distance of the movement of the contact point for the input operation.

71. The input device according to claim 67, wherein the reference position indicating section comprises a reference input sensing section for sensing a contact therewith.

72. The input device according to claim 67, wherein the direction indicating sections are provided eight in number so that the eight characters are inputted by touching them, and the contact point is moved radially inwardly from each of the eight direction indicating sections to the reference position indicating section and is moved radially outwardly from the reference position indicating section to each of the eight direction indicating sections so that a total of 24 characters can be inputted.

73. The input device according to claim 67, wherein the direction indicating sections are provided four in number so that the four characters are inputted by touching them, and the contact point is moved radially inwardly from each of the four direction indicating sections to the reference position indicating section and is moved radially outwardly from the reference position indicating section to each of the four direction indicating sections so that a total of 12 characters can be inputted, and where the reference position indicating section and the direction indicating sections are provided in pairs at the left and right sides of the input region so that a total of 24 characters can be inputted.

74. The input device according to claim 67, further comprising a plurality of auxiliary direction indicating sections provided between the respective direction indicating sections.

75. The input device according to claim 67, wherein the input operation includes the movement of the contact point passing through the reference position indicating section, the forward/rearward and leftward/rightward movement of the contact point at each direction indicating section and consonant characters are inputted by any one of the movement of the contact point passing through the reference position indicating section, the forward/rearward and leftward/rightward movement of the contact point at each direction indicating section, and the contact with each direction indicating section, vowel characters are inputted by another, and various functional commands are inputted by the other.

76. The input device according to claim 67, wherein further comprising a depression sensing section provided at the bottom of the sensing section for detecting the depression of direction indicating section, and
wherein the control section extracts and inputs data corresponding to the depression of each direction indicating section detected by the depression sensing section from the memory and extracts and inputs a more than two different data depending on the strength of the depression of each direction indicating section from the memory.

77. The input device according to claim 67, wherein the direction indicators display a character inputted by the input operation according to each direction indicator.

78. The input device according to claim 67, wherein the reference position indicating section is provided so as to be movable in the input region.

79. The input device according to claim 67, wherein in case where the operation mode of the input device is switched from a character input mode to a mouse input mode, the movement of a pointer is performed by the movement of the contact point and the left and right button functions of the mouse are performed by the touch of the mouse.

80. The input device according to claim 67, wherein in case where the operation mode of the input device is switched from a character input mode to a joystick input mode, the movement of a game character is performed by the movement of the contact point and various manipulation functions of the game character are performed by the touch of the game character.

81. The input device according to claim 80, wherein during the movement of the contact point, as the contact point goes far away from the reference position indicating section, the movement speed of the pointer or the game character is gradually increased.

82. The input device according to claim 80, wherein the reference position indicating section is provided in two sets at the input region, such that the movement of the mouse pointer or the game character is performed by one of the two reference position indicating sections, and the functions of the left and right button of the mouse or various manipulation functions of the game character are performed by the other reference position indicating section.

83. The input device according to claim 66, wherein the respective input operations are performed in a combination of more than two input operations so as to input a Korean character or an English character, and
wherein the respective input operations are performed in an additional combination of more than one input operation so as to input a numeral, a symbol, a mode switch or a function.

84. The input device according to claim 66, wherein the direction indicating sections are provided in any one of four to twelve directions and the movement direction of the contact point passing through the reference position indicating section is provided in the form of any one of four directions and eight directions.

85. The input device according to claim 66, wherein in case where the input operation is performed through the movement of the contact point, a multiple-stage input operation, i.e., a more than two-stage input operation is performed depending on a difference in the movement distance of the contact point.

86. The input device according to claim 66, wherein the sensing section comprises a touch pad or touch screen provided at a base.

87. The input device according to claim 86, wherein in case where the sensing section is provided as the touch screen, a standby region is positioned at one side of the input region comprises, and wherein when the contact point is moved to the standby region in a state where the reference position indicating section or any one of the direction indicators is touched, the direction indicator is hidden into the touch screen and when the reference position indicating section is touched so as to return to the input region, the direction indicators are re-displayed on the input region.

88. The input device according to claim 86, wherein in case where the sensing section is provided as the touch screen, wherein the reference position indicating section or the direction indicating sections and the direction indicators are provided at least two in number so as to be arranged at the edge of the input region or the base adjacent to the touch screen and spaced apart from each other at a predetermined interval.

89. The input device according to claim 66, further comprising a display section for displaying the character extracted by the control section thereon, the display section including a character display part for displaying characters, etc., assigned for each input operation thereon.

90. The input device according to claim 66, wherein a plurality of input targets are arranged at each direction indicating section, and
wherein the control section extracts data corresponding to each input target from the memory and inputs the extracted data, based on a detection result obtained by allowing the sensing section to detect a contact with each input target, an outward contact movement in which the contact point is moved outwardly from the reference position to the outside of each input target, and an inward contact movement in which the contact point is moved inwardly from the reference position to the inside of each input target.

91. The input device according to claim 90, wherein the data corresponding to each input target comprises a first character, a second character and a third character which are separated from one another, the first character being a consonant, the second character being a vowel, and the third character being a consonant or the first character being a consonant, the second character being a consonant, and the third character being a vowel.

92. The input device according to claim 90, wherein the direction indicating sections have the shape of an annular ring formed integrally in its entirety.

93. The input device according to claim 90, wherein the input target for an inward contact movement-based input operation and an outward contact movement-based input operation among the input targets includes a direction indicator indicating a movement direction of the contact point for the input operation.

94. The input device according to claim 90, wherein the direction indicating sections enable a circumferential contact movement-based input operation, and the control section determines the first input operation and the last input operation as a valid input operation when the contact point is moved along a circumferential path during the circumferential contact movement-based input operation and processes the input operation.

95. The input device according to claim 94, wherein the control section performs the input operation after determining that a character corresponding to each input operation is inputted when at least two of a contact-based input operation, the inward contact movement-based input operation, the outward contact movement-based input operation and the circumferential contact movement-based input operation are detected as a one continuous input operation.

96. An input device comprising:
a sensor provided at input region and configured to sense contact with the input region or a contact movement to the input region;
a plurality of direction indicating sections disposed equidistantly at different circumferential positions spaced apart radially outwardly from a reference position provided at the input region; and
a controller configured to extract data corresponding to each input operation from a memory and input the extracted data, according to a contact with each direction indicating section detected by the sensor or the movement direction of the contact point at each direction indicating section.

97. An input device comprising:
means for sensing, provided at input region, contact with the input region or a contact movement to the input region;
a plurality of direction indicating sections disposed equidistantly at different circumferential positions spaced apart radially outwardly from a reference position provided at the input region; and
means for extracting data corresponding to each input operation from a memory and inputting the extracted data, according to a contact with each direction indicating section detected by the sensing means or the movement direction of the contact point at each direction indicating section.
